(19) United States
(12) Patent Application Publication
(10) Pub. No.: US 2026/0342832 A1
(43) Pub. Date: Oct. 29, 2026

(54) SYSTEM

(71) Applicant: SoftBank Group Corp., Tokyo (JP)

(72) Inventor: Tadashi ABE, Tokyo (JP)

(73) Assignee: SoftBank Group Corp., Tokyo (JP)

(21) Appl. No.: 19/649,193

(22) Filed: Apr. 16, 2026

(30) Foreign Application Priority Data
Apr. 23, 2025 (JP) 2025-071602

(51) Int. Cl. H04L 9/40; G06N 3/045

(52) U.S. Cl. CPC H04L 63/1425; G06N 3/045; H04L 63/1433; H04L 63/1441

(57) ABSTRACT

The present invention relates to a cybersecurity system that comprises a data collection unit, an analysis unit, an incident response unit, and the like distributed and arranged in terminals and servers, and by using a generative AI as an essential component, integrally collects, in real time, various security-related data from network traffic, system logs, various terminals, and cloud services, and integrally and autonomously executes advanced abnormality detection and threat prediction by AI, automatic collection and analysis of external threat intelligence, as well as automatic defensive measures, preservation of evidence, notification to an administrator, and system optimization, and is characterized by fundamentally solving on-site problems such as the sophistication of cyberattacks, a shortage of security personnel, and a massive log analysis burden, and dramatically improving the security level of the entire organization.

### CROSS-REFERENCE TO RELATED APPLICATION

The present application claims priority to and incorporates by reference the entire contents of Japanese Patent Application No. 2025-071602 filed in Japan on Apr. 23, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

The problem to be solved by the present invention is that, with the sophistication and increase of cyberattacks, it becomes difficult to respond to unknown attacks and zero-day attacks with conventional signature-based and rule-based security measures, and furthermore, the burden of analyzing a massive amount of security-related data such as network traffic and system logs is increasing; in addition, due to a shortage of security personnel, advanced threat detection and rapid incident response cannot be sufficiently realized; and it is difficult to integrally and in real time monitor and analyze data generated from various information sources such as a plurality of network devices, endpoint terminals, and cloud services, and to realize automatic defense and incident response reflecting the latest threat information. Furthermore, the problem also includes that, in conventional manual operation, there is a high risk of overlooking an abnormality or a sign of an attack from a massive amount of logs, and an efficient and advanced system is required to automate a series of responses such as initial response when an attack occurs, preservation of evidence, and rapid notification to an administrator, and to improve the security level as a whole.

### SUMMARY OF THE INVENTION

Means for solving the problem according to the present invention is to provide a system comprising: a data collection unit configured to collect a plurality of types of security-related data such as network traffic and system logs in real time; an analysis unit configured to analyze the data collected by the data collection unit using a generative AI, and detect a sign of an unknown or known cyberattack or an abnormal behavior by comparison with a past normal behavior pattern or collation with a threat information database; and an incident response unit configured to automatically execute a defensive measure against the abnormality or threat detected by the analysis unit, and further perform preservation of an evidence and notification to an administrator when an incident occurs, wherein the analysis unit operates with the generative AI as an essential component, automatically collects latest threat information from an external threat intelligence source, and updates the threat information database at any time, the incident response unit performs immediate notification to the administrator and preservation of evidence data after executing the automatic defensive measure, and a series of these processes is automatically and continuously executed.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

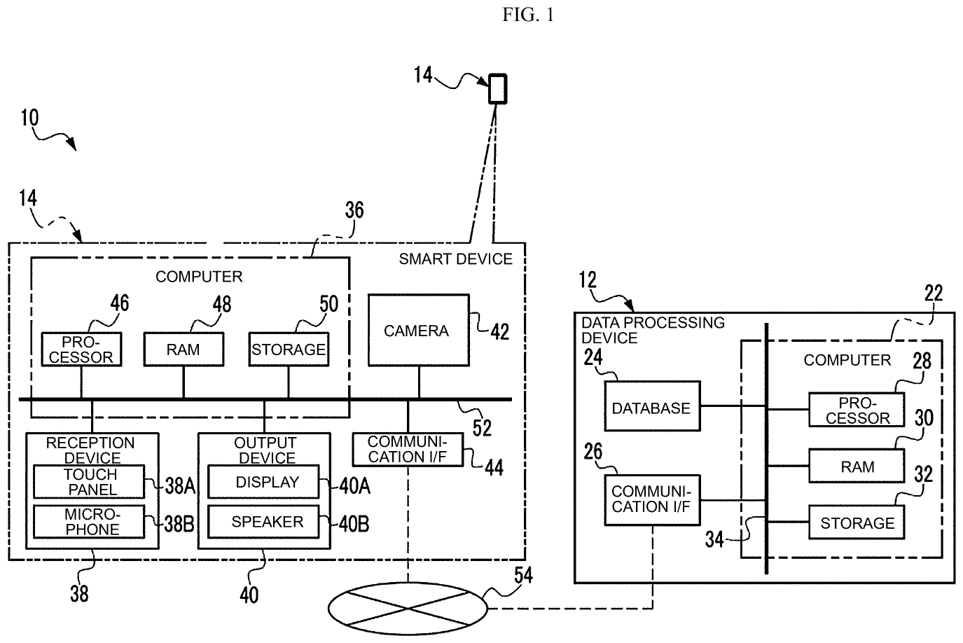

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

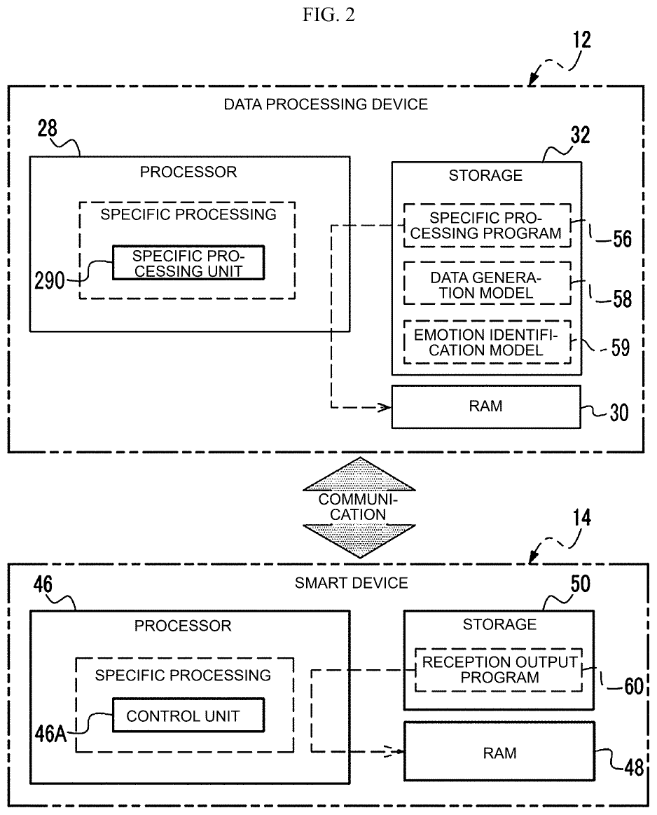

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying out the Present Invention

Embodiments of the present invention will be described more specifically and in detail. The system of the present invention has, as its core, a data collection unit, an analysis unit, and an incident response unit configured to be distributed to a server and terminals, and these units operate in cooperation with a generative AI as an essential component, thereby realizing advanced automatic threat detection, defense, and response, which have been difficult to realize with conventional security systems. Specifically, the present system adopts a distributed computing architecture. The present system connects a plurality of computing nodes via a network. The present system allocates a dedicated processing module to each node. The present system arranges the data collection unit in both an edge device and a cloud server. The present system implements a large language model and a neural network for time-series analysis as the analysis unit. The present system includes a hybrid control mechanism combining a rule-based engine and a reinforcement learning agent as the incident response unit. The present system causes these units to cooperate via a high-speed internal bus and an encrypted communication protocol. The present system executes inference processing of the generative AI on a parallel computing cluster. The present system receives a multidimensional time-series tensor collected from each terminal as input data. The present system normalizes the multidimensional time-series tensor. The present system inputs the normalized tensor to a transformer model having a self-attention mechanism. The present system generates a threat score and an abnormality classification label as an output of the transformer model. The present system immediately activates the incident response unit when the threat score exceeds a predetermined threshold. The present system completely replaces conventional log monitoring work by humans. The present system mathematically extracts an unknown threat pattern by vector operation in a high-dimensional space. The present system thereby shortens the time required for threat detection to the order of milliseconds. The present system significantly reduces a false positive rate. The present system exhibits an extremely high technical effect in use cases such as protection of a large-scale corporate network or infrastructure of a government agency. The present system optimizes consumption of hardware resources. The present system suppresses wasteful consumption of a communication band. The present system dramatically improves the operating efficiency of computer technology itself.

First, the data collection unit will be described. The data collection unit is composed of an agent program installed on a terminal side and a centralized management module installed on a server side. The terminal-side agent supports various OS environments such as Windows-based, Linux-based, macOS-based, and mobile terminals (smartphones, tablets, etc.), and collects, in real time or periodically, all security-related data generated in the terminal, such as a system log, an application log, a file access history, a USB device connection history, a process start/end history, a communication history of a network interface, a user authentication history, an administrator privilege operation history, a browser access history, an email transmission/reception history, an external storage usage history, a VPN connection history, and a remote desktop connection history of each terminal. For example, when a USB memory is connected, its device ID, connection time, accessed file name, presence or absence of a copy operation, and the like are recorded in detail. Furthermore, even when a suspicious process is started on the terminal or when an operation is performed with administrator privileges in an unusual time zone, the information is immediately collected. Specifically, the present data collection unit includes a hook driver that operates at a kernel level of an operating system. The present data collection unit constantly monitors issuance of a system call. The present data collection unit converts the acquired raw data into a structured JSON format log entry. The present data collection unit temporarily stores the log entry in a ring buffer on a memory. The present data collection unit divides the data in the ring buffer into a certain chunk size. The present data collection unit applies a hash function to the divided chunks to ensure data integrity. The present data collection unit reduces the data size of the chunks using a compression algorithm. The present data collection unit transmits the compressed data to the centralized management module on the server side via a secure communication channel. The present data collection unit minimizes consumption of a network band. The present data collection unit implements an asynchronous processing mechanism for reducing a CPU load of the terminal. The present data collection unit encodes the collected data into a multidimensional numerical vector. The present data collection unit converts, for example, a process start history into a one-hot vector. The present data collection unit expresses a file access frequency as a time-series array of floating-point numbers. The present data collection unit shapes this numerical vector as input data to a subsequent AI model. The present data collection unit fixes the number of dimensions of the input data to, for example, 512 dimensions. The present data collection unit complements a missing value by zero-padding processing. The present data collection unit thereby improves the inference accuracy of the AI model. Unlike conventional text-based log analysis, the present data collection unit treats data as coordinate points in a high-dimensional space. The present data collection unit makes it possible to detect the behavior of unknown malware as a mathematical outlier by this unconventional data processing method. The present data collection unit is applied to use cases such as terminal monitoring of a financial institution and protection of an electronic medical record system of a medical institution. The present data collection unit brings about clear technical effects of improving the efficiency of data management and reducing a communication load.

The data collection unit on the server side collects a traffic log, flow information, packet capture data, an external communication destination IP address, a port number, a communication protocol, a communication amount, geographical information of a communication destination, a DNS query history, an API access log of a cloud service, a usage history of an external storage service, an authentication/operation history of a SaaS application, and the like from network devices (routers, switches, firewalls, IDS/IPS, proxy servers, etc.). For example, details of blocked communication are acquired from a firewall, detected attack signatures and alert information are acquired from an IDS/IPS, URLs of Web access and POST/GET request contents are acquired from a proxy server, and usage statuses of API keys and abnormal access patterns are acquired from a cloud service. These data are centrally managed on the server side and integrated with the data transmitted from the terminal side. Specifically, the present server-side data collection unit operates a plurality of asynchronous IO threads in parallel. The present server-side data collection unit receives a massive amount of log events reaching millions of cases per second. The present server-side data collection unit expands the received event stream into an in-memory database. The present server-side data collection unit extracts a feature amount from each log event. The present server-side data collection unit converts, for example, an IP address into a 32-dimensional embedding vector. The present server-side data collection unit encodes a port number and a protocol type as categorical variables. The present server-side data collection unit expresses a fluctuation in communication amount as a one-dimensional time-series tensor. The present server-side data collection unit combines these feature amounts to generate, for example, a 1024-dimensional integrated feature vector. The present server-side data collection unit inputs this integrated feature vector to a subsequent neural network for abnormality detection. The present server-side data collection unit synchronizes the data transmitted from the terminal side and the data from the network device based on a time stamp. The present server-side data collection unit reconstructs the synchronized data as graph structure data. The present server-side data collection unit executes preprocessing for inputting this graph structure data to a graph convolutional network. The present server-side data collection unit is different from a conventional simple storage process in a relational database. The present server-side data collection unit maps data to a high-dimensional tensor space. The present server-side data collection unit dramatically improves the data search speed inside the computer by this processing. The present server-side data collection unit is extremely effective in use cases such as monitoring of a large-scale cloud infrastructure and protection of a core network of a telecommunications carrier. The present server-side data collection unit exhibits a technical effect of improving the calculation efficiency of a data integration process. The present server-side data collection unit provides a foundation for a subsequent AI model to accurately learn a complex attack pattern.

Next, the analysis unit will be described. The analysis unit has its main function implemented on the server side, but also arranges a lightweight AI model on the terminal side to perform primary abnormality detection and data preprocessing locally on the terminal. The core of the analysis unit is a generative AI, and uses, for example, a deep learning-based abnormality detection model, a time-series analysis model, a natural language processing model, a large language model, a self-supervised learning model, a generative adversarial network (GAN), and the like in combination. The generative AI first learns past normal communication patterns, user behavior patterns, normal operation histories for each terminal, usage tendencies for each business system, and the like from a massive amount of data. For example, it grasps a tendency that a certain terminal frequently accesses a specific business system during the daytime on weekdays, but is rarely used late at night or on holidays. Thereby, when a massive file transfer or external communication occurs late at night, it can be immediately detected as an abnormality. Specifically, the present analysis unit adopts a hierarchical neural network architecture. The present analysis unit implements a convolutional neural network for mobile with a reduced number of parameters on the terminal side. The present analysis unit extracts a local feature map from the input time-series log tensor using this lightweight model. The present analysis unit transmits the extracted feature map to a main model on the server side. The present analysis unit arranges a transformer-based large language model having billions of parameters on the server side. The present analysis unit executes pre-training using a self-attention mechanism for this large language model. The present analysis unit receives, for example, a sequence of 512-dimensional token embedding vectors as input data. In the present analysis unit, this sequence includes a user operation history and header information of a communication packet. The present analysis unit generates a distribution of abnormality probability scores for each token as an output of the large language model. The present analysis unit determines that the operation is a malicious behavior when this abnormality probability score exceeds 0.95. The present analysis unit further generates a massive amount of pseudo data of normal communication patterns using a generative adversarial network. The present analysis unit updates weights of a discriminator network using this pseudo data. The present analysis unit minimizes a loss function using a backpropagation method and a stochastic gradient descent method. The present analysis unit uses a linear combination of a cross-entropy error and a reconstruction error as the loss function. The present analysis unit dramatically improves detection accuracy against an unknown zero-day attack by this learning process. The present analysis unit completely eliminates rule creation work by humans, which is a conventional signature-based detection method. The present analysis unit mathematically constructs a non-linear decision boundary in a high-dimensional feature space. The present analysis unit improves the inference processing speed of a computer by this unconventional processing method. The present analysis unit is applied to use cases such as fraudulent remittance detection of a financial institution and cyberattack defense of critical infrastructure. The present analysis unit brings about clear technical effects of reducing false positives and early discovering unknown threats.

In addition, the generative AI automatically collects latest threat information from an external threat intelligence source (a vulnerability information sharing platform, a security community, published attack campaign information, a malware analysis report, threat information on the dark web, attack warning information on SNS, etc.), extracts and summarizes useful information using natural language processing technology, and dynamically updates a threat information database. For example, it automatically collects characteristics of ransomware newly discovered around the world, methods of targeted attacks aimed at specific industries, cases of exploiting zero-day vulnerabilities, and the like, and immediately reflects them in existing signatures and detection rules. Furthermore, the generative AI analyzes correlations among a plurality of log data, and detects signs of complex attack scenarios with high accuracy, such as “simultaneous logins from a plurality of terminals by the same user”, “continuous occurrence of privilege escalation and external communication in a short time”, and “suspicious communications occurring simultaneously at a plurality of bases”. Specifically, the present generative AI drives a web scraping module and an API cooperation module. The present generative AI inputs the collected unstructured text data to a natural language processing pipeline. The present generative AI divides the text data into tokens in units of words or subwords. The present generative AI converts each token into, for example, a 768-dimensional dense vector. The present generative AI inputs this sequence of dense vectors to a bidirectional encoder representations model. The present generative AI acquires a sequence of named entity labels indicating a threat actor name and an attack method as an output of the model. The present generative AI structures the extracted named entities as nodes and edges of a knowledge graph. The present generative AI inputs this knowledge graph to a graph neural network. The present generative AI generates a prediction vector of a new attack pattern as an output of the graph neural network. The present generative AI calculates a cosine similarity between this prediction vector and a feature vector extracted from an internal log. The present generative AI detects the occurrence of a complex attack scenario when the similarity exceeds a predetermined threshold. The present generative AI receives, for example, a text that new ransomware scans port 445 as an input. The present generative AI generates a structured JSON format threat indicator such as port 445, scan, and ransomware as an output. The present generative AI immediately adds this threat indicator to a dynamic access control list of a firewall. The present generative AI completely replaces manual report analysis work by a human security analyst. The present generative AI executes an unconventional mathematical process of mapping from a natural language space to a feature vector space. The present generative AI shortens a reflection delay of threat information from several days to several seconds by this processing. The present generative AI exhibits an extremely high technical effect in use cases such as an integrated security operations center of a global company. The present generative AI provides a mechanism for autonomously improving the defense capability of the entire system.

The lightweight AI model on the terminal side executes, for example, malware behavior detection, abnormal process start detection, user operation deviation detection, suspicious use detection of a USB device, and the like locally on the terminal in real time, and immediately transmits detailed data to the analysis unit on the server side when an abnormality is detected. On the server side, multidimensional analysis is performed by a more advanced generative AI to grasp a company-wide threat situation. Specifically, the present lightweight AI model on the terminal side reduces the precision of a weight parameter from a 32-bit floating point to an 8-bit integer using a quantization technique. The present lightweight AI model thereby reduces the memory consumption and CPU usage rate of the terminal to the utmost limit. The present lightweight AI model receives an API call history of an operating system as a time-series one-hot encoding matrix as input data. The present lightweight AI model inputs this matrix to a long short-term memory network, which is a variant of a recurrent neural network. The present lightweight AI model sequentially updates a hidden state vector of the long short-term memory network. The present lightweight AI model inputs a final hidden state vector to a fully connected layer. The present lightweight AI model calculates an abnormality score in a range of 0 to 1 as an output of the fully connected layer. The present lightweight AI model determines that the process is malicious when this abnormality score exceeds, for example, 0.85. The present lightweight AI model generates a multidimensional tensor including a memory dump and a network connection state of the corresponding process together with a determination result. The present lightweight AI model transmits this multidimensional tensor to the analysis unit on the server side by asynchronous communication. The present analysis unit on the server side inputs this multidimensional tensor to a large-scale ensemble learning model. The present analysis unit on the server side integrates output results of a plurality of algorithms such as a random forest and a gradient boosting decision tree. The present analysis unit on the server side outputs a company-wide threat level as a five-stage categorical label based on this integration result. The present system adopts an unconventional distributed processing architecture that fuses edge computing and cloud computing. The present system prevents depletion of a network band by this architecture. The present system significantly reduces a calculation load on the server side. The present system is applied to use cases such as monitoring of a group of IoT devices on a scale of tens of thousands and terminal management of a large-scale office. The present system brings about clear technical effects of improving the real-time property of processing and ensuring the scalability of the entire system.

The incident response unit will be described. The incident response unit automatically executes a defensive measure against an abnormality or threat detected by the analysis unit, and further performs preservation of an evidence and notification to an administrator when an incident occurs. For example, when a malware infection is detected on the terminal side, the terminal agent automatically disables a network interface, the incident response unit on the server side transmits a detailed notification to the administrator, and preserves evidence data (a log at the time of detection, a communication packet, a system state, a user operation history, a memory dump, etc.) in a secure storage. On the server side, traffic of the entire network is monitored, and communication from a suspicious IP address is immediately blocked by a firewall, or when expansion of infection to a plurality of terminals is suspected, the corresponding terminal group is simultaneously isolated from the network. For example, when an abnormality in API access is detected on a cloud service, the incident response unit on the server side automatically executes invalidation of the corresponding API key and blocking of an access source IP, and simultaneously automatically generates and transmits a detailed incident report to the administrator. Specifically, the present incident response unit implements an autonomous agent based on a reinforcement learning algorithm. The present incident response unit receives a threat score and an abnormality classification label output from the analysis unit as a state vector. The present incident response unit maps this state vector to a framework of a Markov decision process. The present incident response unit calculates an optimal action value function in each state using a deep Q-network. The present incident response unit selects a defensive action that maximizes the action value function. The present incident response unit receives, for example, a state vector indicating a ransomware infection probability of 0.98 in a terminal A as an input. The present incident response unit generates a control command group of shutting down a network interface of the terminal A and blocking a related communication port as an output. The present incident response unit directly issues this control command group to a kernel module of an operating system. The present incident response unit simultaneously hashes the evidence data and records it in a blockchain-based distributed ledger. The present incident response unit mathematically proves the non-tampering property of the evidence data by this processing. The present incident response unit transmits a RESTful control request to an API gateway in a cloud environment. The present incident response unit immediately revokes the authority of a specific API key by this request. The present incident response unit completely eliminates manual command input work by a human system administrator. The present incident response unit executes an unconventional arithmetic processing of mapping from a high-dimensional state space to an optimal action space. The present incident response unit shortens a lead time from the occurrence of an incident to the completion of a defensive measure to the order of several milliseconds by this arithmetic processing. The present incident response unit physically and logically contains the expansion of damage. The present incident response unit exhibits an extremely high technical effect in use cases such as an automatic defense system of a data center and a fail-safe mechanism of critical infrastructure. The present incident response unit dramatically improves the availability and integrity of a computer system.

The generative AI is also utilized in a multifaceted manner in the incident response unit. For example, it automatically summarizes the content and impact range of a detected threat, generates a notification text to an administrator, and proposes an optimal response procedure by referring to a past incident response history. Furthermore, when a plurality of incidents occur simultaneously, the generative AI automatically evaluates priorities and impact ranges, and optimizes prioritization of responses and resource allocation. For example, when abnormalities are detected in a plurality of terminals simultaneously, those having a wide impact range or those related to an important business system are preferentially responded to, and the administrator is notified to that effect. Specifically, the present generative AI constructs a dedicated inference pipeline in the incident response unit. The present generative AI receives a structured JSON array including a plurality of alert information as input data. The present generative AI converts this JSON array into a natural language prompt character string. The present generative AI inputs this prompt character string to a transformer model on a scale of billions of parameters. The present generative AI autoregressively generates a natural language text sequence according to a context using a decoder layer of the transformer model. The present generative AI receives, for example, data indicating port scan detection in a terminal group B as an input. The present generative AI generates, as an output, text data including a specific response procedure recommending that a port scan intended for horizontal expansion to an internal network is in progress in the terminal group B and a VLAN of the corresponding segment should be immediately isolated. The present generative AI further inputs feature vectors of a plurality of incidents to a clustering algorithm. The present generative AI groups an incident group in a multidimensional space using an algorithm such as K-means or DBSCAN. The present generative AI calculates a Euclidean distance between a centroid vector of each group and a profile vector of an important asset. The present generative AI assigns a high priority score to a group having a short distance. The present generative AI dynamically rearranges an incident response queue in descending order of this priority score. The present generative AI completely replaces triage work based on a rule of thumb by a human operator. The present generative AI optimizes resource allocation by a mathematical approach of distance calculation in a high-dimensional vector space. The present generative AI is applied to use cases such as reduction of alert fatigue and prevention of response omission in a large-scale security operations center. The present generative AI brings about clear technical effects of improving the throughput of an incident response process and efficiently operating system resources.

Also in the preservation of evidence data, the generative AI automatically classifies and organizes the importance and relevance of data, and efficiently manages the data in preparation for a forensic investigation or an audit at a later date. For example, it automatically extracts a communication packet, a file operation history, trace information of a system call, and the like that become traces of an attack, and collectively preserves them in chronological order for each related incident. Specifically, the present generative AI drives a dedicated neural network module for evidence data management. The present generative AI receives a binary stream of petabyte-class unstructured log data and a packet capture file as input data. The present generative AI divides this binary stream into fixed-length chunks. The present generative AI executes dimensional compression using an autoencoder for each chunk. The present generative AI generates a compressed latent variable vector. The present generative AI inputs this latent variable vector to a clustering engine based on cosine similarity. The present generative AI groups a data group having similar features as the same incident cluster. The present generative AI calculates an importance score for each cluster. The present generative AI receives, for example, a tensor of a suspicious registry change history and an encrypted communication packet to the outside as an input. The present generative AI generates, as an output, a relevance link graph indicating that these data originate from the same malware infection process. The present generative AI stores the data in a time-series graph database based on this link graph. The present generative AI applies a lossy compression algorithm to data having a low importance score to save storage capacity. The present generative AI encrypts and preserves data having a high importance score in a redundant secure storage. The present generative AI completely eliminates manual data sorting work by a human forensic investigator. The present generative AI mathematically proves the relevance of data by an unconventional processing method of vector operation in a latent space. The present generative AI exhibits an extremely high technical effect in use cases such as a cybercrime investigation by a law enforcement agency and an internal audit of a company. The present generative AI dramatically improves the consumption efficiency of storage resources. The present generative AI shortens the time required for data search and extraction from several hours to several seconds.

Furthermore, an automatic tuning function of the entire system is also realized by the generative AI. For example, for the purpose of improving detection accuracy and reducing false positives, it learns past detection results and feedback from an administrator, and automatically optimizes a detection model and a defensive rule. For example, when a false positive frequently occurs in a certain terminal, it learns a usage pattern specific to the terminal, and automatically adjusts a threshold value to be regarded as normal thereafter. In addition, when a new attack method is discovered, it immediately updates the detection model based on information obtained from external threat intelligence, and reflects it in all terminals and all network devices. Specifically, the present generative AI implements mechanisms of continuous learning and online learning inside the system. The present generative AI receives a feedback input from the administrator as a binary correct label. The present generative AI calculates a cross-entropy error between this correct label and a past inference result. The present generative AI fine-tunes a weight parameter of a neural network by a backpropagation method using this error signal. The present generative AI extracts a false positive event in a specific terminal as a multidimensional feature vector. The present generative AI maps this feature vector to an input space of a support vector machine. The present generative AI dynamically recalculates a non-linear decision boundary using a kernel trick. The present generative AI automatically updates a threshold parameter for abnormality determination based on this recalculated decision boundary. The present generative AI receives, for example, a feature tensor of frequent compilation processing and large-capacity file transfer in a developer terminal as an input. The present generative AI generates a dedicated relaxed threshold matrix for this specific terminal profile as an output. The present generative AI vectorizes a new attack signature acquired from external threat intelligence. The present generative AI adds this vector to a weight matrix of an existing detection model. The present generative AI differentially distributes the updated model parameter to agents of all terminals using a federated learning technique. The present generative AI completely replaces manual parameter adjustment and patch application work by a human engineer. The present generative AI executes a mathematical process of dynamic optimization of a decision boundary in a high-dimensional space. The present generative AI is applied to use cases such as operation management of a large-scale enterprise network and automation of a managed security service. The present generative AI continuously lowers the false positive rate of the system. The present generative AI brings about clear technical effects of preventing obsolescence of a model and improving the long-term reliability of a computer system.

As described above, the system of the present invention distributes and arranges functions in both a server and terminals, places a generative AI at the core, and automates and sophisticates all processes of data collection, analysis, defense, incident response, evidence preservation, and system optimization, thereby fundamentally solving on-site problems such as the sophistication of cyberattacks, a shortage of security human resources, and an enormous log analysis burden, and dramatically improving the security level of the entire organization. For example, a major feature of the present invention is that it can respond in real time and autonomously to various attack scenarios such as targeted attacks, ransomware attacks, internal frauds, zero-day attacks, supply chain attacks, unauthorized access to cloud services, attacks via IoT devices, and new threats in remote work environments. Specifically, the system includes an orchestration engine that dynamically distributes a calculation load between edge nodes and a cloud cluster. The system containerizes each process as a microservice architecture. The system controls communication between containers via a service mesh. The system executes inference processing of the generative AI at high speed on a parallel computing cluster using GPUs. The system receives, as input data, a huge multidimensional tensor integrating traffic flows of the entire network, system call histories of endpoints, and API access logs of cloud resources. The system inputs this multidimensional tensor in parallel to a plurality of specialized neural network models. The system integrates output scores from the respective models by an ensemble learning algorithm. The system generates a sequence of autonomous defensive actions based on the integrated threat probability score. The system receives, for example, as an input, a vector indicating simultaneous occurrence of abnormal beacon communication from an IoT device and massive data export to a cloud storage. The system generates, as an output, a classification label indicating the progress of a supply chain attack and a group of control commands for blocking a corresponding IoT segment and freezing a cloud account. The system completely eliminates a non-technical process of conventional monitoring work by humans. The system executes a mathematical algorithm based on pattern recognition in a high-dimensional data space and optimal control theory. The system minimizes latency from detection of a cyberattack to defense by this unconventional processing method. The system exhibits an extremely high technical effect in use cases such as global network protection of multinational corporations and national-level critical infrastructure defense. The system maximizes utilization efficiency of hardware resources. The system dramatically improves robustness and self-healing capability of the entire computer network.

### System Configuration

The system according to the present embodiment includes a data collection unit, an analysis unit, an incident response unit, a threat information update unit, an evidence management unit, a notification generation unit, and a system optimization unit. The data collection unit is composed of an agent program installed on a terminal side and a centralized management module on a server side, and collects, in real time or periodically, various security-related data generated in the terminal, such as a system log, an application log, a file access history, a USB device connection history, a process start/end history, a network interface communication history, a user authentication history, an administrator privilege operation history, a browser access history, an email transmission/reception history, an external storage usage history, a VPN connection history, and a remote desktop connection history of each terminal. For example, when a USB memory is connected, its device ID, connection time, accessed file name, and presence or absence of a copy operation are recorded in detail, and also when a suspicious process is started on the terminal or when an operation is performed with administrator privileges in a time zone different from normal, the information is immediately collected. The data collection unit on the server side collects a traffic log, flow information, packet capture data, an external communication destination IP address, a port number, a communication protocol, a communication amount, geographical information of a communication destination, a DNS query history, an API access log of a cloud service, a usage history of an external storage service, an authentication/operation history of a SaaS application, and the like from network devices, acquires, for example, details of blocked communication from a firewall, detected attack signatures and alert information from an IDS or IPS, a URL of Web access and POST/GET request contents from a proxy server, and a usage status of an API key and an abnormal access pattern from a cloud service, centrally manages these data on the server side, and integrates the data with data transmitted from the terminal side. Specifically, the system deploys each component as an independent arithmetic process in a memory space. The system links each unit at high speed using an inter-process communication protocol. The data collection unit utilizes a kernel driver deeply integrated into an operating system layer of the terminal. The data collection unit directly hooks hardware interrupts and system calls via this kernel driver. The data collection unit parses the acquired raw data from a binary format into a structured JSON format. The data collection unit accumulates this JSON data in a buffer area on a memory. The data collection unit batch-processes the data in the buffer at regular time intervals and converts the data into a multidimensional numerical vector. The data collection unit performs one-hot encoding using, for example, a vendor ID and a product ID of a USB device as categorical variables. The data collection unit normalizes a file access size and the number of communication bytes by logarithmic transformation. The data collection unit combines these converted numerical values to generate, for example, a 256-dimensional feature vector. The data collection unit transmits this feature vector to the server via an encrypted TLS session. The data collection unit on the server side utilizes DPDK, which is a high-speed packet processing framework. The data collection unit on the server side bypasses a network stack of a kernel by this framework. The data collection unit on the server side directly processes traffic data of several gigabits per second in a user space. The data collection unit on the server side extracts a source IP address and a destination port number from a packet header. The data collection unit on the server side maps this extracted data to a 32-dimensional embedding vector space. The data collection unit on the server side combines the feature vector from the terminal and the embedding vector from the network using a time stamp as a key. The data collection unit on the server side generates, for example, a 1024-dimensional integrated tensor by this combining process. Unlike conventional simple log transfer processing, the data collection unit treats data as coordinate points in a high-dimensional space. The data collection unit improves inference accuracy of a subsequent AI model by this unconventional data processing method. The data collection unit is applied to use cases such as monitoring of a large-scale enterprise network and traffic analysis of a cloud data center. The data collection unit brings about clear technical effects of speeding up data processing and saving a communication bandwidth.

The analysis unit has its main function implemented on the server side, but also arranges a lightweight AI model on the terminal side to perform primary abnormality detection and data preprocessing locally on the terminal. The core of the analysis unit is a generative AI, and uses a combination of a deep learning-based abnormality detection model, a time-series analysis model, a natural language processing model, a large language model, a self-supervised learning model, a generative adversarial network, and the like. The analysis unit learns past normal communication patterns, user behavior patterns, normal operation histories for each terminal, usage tendencies for each business system, and the like from a massive amount of data, grasps a tendency that, for example, in a certain terminal, there are many accesses to a specific business system during the day on weekdays, but it is hardly used late at night or on holidays, and immediately detects an abnormality when massive file transfer or external communication occurs late at night. In addition, the analysis unit automatically collects latest attack methods and malware information from an external threat intelligence source, extracts and summarizes useful information using natural language processing technology, and dynamically updates a threat information database. For example, it automatically collects characteristics of ransomware newly discovered around the world, methods of targeted attacks aimed at specific industries, abuse cases of zero-day vulnerabilities, and the like, and immediately reflects them in existing signatures and detection rules. Furthermore, the analysis unit analyzes correlations among a plurality of log data, and detects, with high accuracy, signs of complex attack scenarios such as simultaneous logins from a plurality of terminals by the same user, continuous occurrence of privilege escalation and external communication in a short time, and suspicious communications occurring simultaneously at a plurality of bases. The lightweight AI model on the terminal side executes, in real time, malware behavior detection, abnormal process start detection, user operation deviation detection, suspicious use detection of a USB device, and the like locally on the terminal, immediately transmits detailed data to the analysis unit on the server side when an abnormality is detected, and performs multidimensional analysis by a more advanced generative AI on the server side to grasp a company-wide threat situation. Specifically, the analysis unit adopts a distributed machine learning architecture. The analysis unit implements a lightweight convolutional neural network compressed using knowledge distillation technology on the terminal side. The analysis unit extracts a local feature map from an input time-series log tensor using this lightweight model. The analysis unit transmits the extracted feature map to a main model on the server side. The analysis unit arranges a transformer-based large language model having billions of parameters on the server side. The analysis unit executes pre-training using a self-attention mechanism for this large language model. The analysis unit receives, for example, a sequence of 512-dimensional token embedding vectors as input data. In the analysis unit, this sequence includes a user operation history and header information of a communication packet. The analysis unit generates a distribution of an abnormality probability score for each token as an output of the large language model. The analysis unit determines that the operation is a malicious behavior when this abnormality probability score exceeds 0.95. The analysis unit further generates a massive amount of pseudo data of normal communication patterns using a generative adversarial network. The analysis unit updates weights of a discriminator network using this pseudo data. The analysis unit minimizes a loss function using a backpropagation method and a stochastic gradient descent method. The analysis unit uses a linear combination of a cross-entropy error and a reconstruction error as the loss function. The analysis unit inputs unstructured text data collected from an external threat intelligence source to a natural language processing pipeline. The analysis unit divides the text data into tokens in units of words or subwords. The analysis unit converts each token into, for example, a 768-dimensional dense vector. The analysis unit inputs this sequence of dense vectors to a bidirectional encoder representations model. The analysis unit acquires a sequence of named entity labels indicating a threat actor name and an attack method as an output of the model. The analysis unit structures the extracted named entities as nodes and edges of a knowledge graph. The analysis unit inputs this knowledge graph to a graph neural network. The analysis unit generates a prediction vector of a new attack pattern as an output of the graph neural network. The analysis unit calculates a cosine similarity between this prediction vector and a feature vector extracted from an internal log. The analysis unit detects occurrence of a complex attack scenario when the similarity exceeds a predetermined threshold. The analysis unit completely eliminates a rule creation work by a human, which is a conventional signature-based detection method. The analysis unit mathematically constructs a non-linear decision boundary in a high-dimensional feature space. The analysis unit improves an inference processing speed of a computer by this unconventional processing method. The analysis unit is applied to use cases such as fraudulent remittance detection of financial institutions and cyberattack defense of critical infrastructure. The analysis unit brings about clear technical effects of reducing false positives and early discovering unknown threats.

The incident response unit automatically executes a defensive measure against the abnormality or threat detected by the analysis unit, and performs preservation of an evidence and notification to an administrator when an incident occurs. For example, when a malware infection is detected on the terminal side, a terminal agent automatically disables a network interface, and the incident response unit on the server side transmits a detailed notification to the administrator and stores evidence data in a secure storage. On the server side, traffic of the entire network is monitored, and communication from a suspicious IP address is immediately blocked by a firewall, or when spread of infection to a plurality of terminals is suspected, corresponding terminal groups are simultaneously isolated from the network. For example, when an abnormality in API access is detected on a cloud service, the incident response unit on the server side automatically executes invalidation of a corresponding API key and blocking of an access source IP, and simultaneously automatically generates and transmits a detailed incident report to the administrator. Furthermore, the incident response unit can automatically block use of a corresponding device and notify the administrator when suspicious use of a USB device is detected on the terminal side. Specifically, the incident response unit implements an autonomous agent based on a reinforcement learning algorithm. The incident response unit receives a threat score and an abnormality classification label output from the analysis unit as a state vector. The incident response unit maps this state vector to a framework of a Markov decision process. The incident response unit calculates an optimal action-value function in each state using a deep Q-network. The incident response unit selects a defensive action that maximizes the action-value function. The incident response unit receives, for example, as an input, a state vector indicating a ransomware infection probability of 0.98 in a terminal A. The incident response unit generates, as an output, a group of control commands for shutting down a network interface of the terminal A and blocking related communication ports. The incident response unit directly issues this group of control commands to a kernel module of an operating system. The incident response unit simultaneously hashes the evidence data and records it in a blockchain-based distributed ledger. The incident response unit mathematically proves non-tampering of the evidence data by this processing. The incident response unit transmits a RESTful control request to an API gateway in a cloud environment. The incident response unit immediately revokes an authority of a specific API key by this request. The incident response unit intervenes in a load process of a device driver when detecting a connection event of a USB device. The incident response unit rejects loading of a device having an unapproved vendor ID at a kernel level. The incident response unit completely eliminates a manual command input work by a human system administrator. The incident response unit executes unconventional arithmetic processing of mapping from a high-dimensional state space to an optimal action space. The incident response unit shortens a lead time from occurrence of an incident to completion of a defensive measure to a unit of several milliseconds by this arithmetic processing. The incident response unit physically and logically contains spread of damage. The incident response unit exhibits an extremely high technical effect in use cases such as an automatic defense system of a data center and a fail-safe mechanism of critical infrastructure. The incident response unit dramatically improves availability and integrity of a computer system.

The threat information update unit automatically collects latest attack methods, malware information, zero-day vulnerability information, trends of targeted attacks, attack warning information on the dark web, security-related information on SNS, and the like from an external threat intelligence source, extracts and summarizes useful information using a generative AI, and dynamically updates a threat information database. For example, it acquires new vulnerability information from a vulnerability information sharing platform, extracts characteristics of an attack code and abuse cases to reflect them in the database, or automatically analyzes behavior information of a new type of malware shared in a security community to generate a signature. Specifically, the threat information update unit operates a distributed web crawler and an API polling module in parallel. The threat information update unit inputs collected unstructured text data and HTML documents to a natural language processing pipeline. The threat information update unit divides the text data into tokens in units of words or subwords. The threat information update unit converts each token into, for example, a 768-dimensional dense vector. The threat information update unit inputs this sequence of dense vectors to a bidirectional encoder representations model. The threat information update unit acquires a sequence of named entity labels indicating a threat actor name and an attack method as an output of the model. The threat information update unit structures the extracted named entities as nodes and edges of a knowledge graph. The threat information update unit inputs this knowledge graph to a graph neural network. The threat information update unit generates a prediction vector of a new attack pattern as an output of the graph neural network. The threat information update unit receives, for example, as an input, a text that a new ransomware scans port 445. The threat information update unit generates, as an output, a structured JSON-format threat indicator such as port 445, scan, and ransomware. The threat information update unit immediately inserts this threat indicator into an internal threat information database. The threat information update unit automatically rewrites a dynamic access control list of a firewall using an update trigger of this database. The threat information update unit completely substitutes a manual report analysis work by a human security analyst. The threat information update unit executes unconventional mathematical processing of mapping from a natural language space to a feature vector space. The threat information update unit shortens a reflection delay of threat information from several days to several seconds by this processing. The threat information update unit exhibits an extremely high technical effect in use cases such as an integrated security operations center of a global enterprise. The threat information update unit provides a mechanism for autonomously improving a defense capability of the entire system.

The evidence management unit automatically classifies and organizes evidence data (logs at the time of detection, communication packets, system states, user operation histories, memory dumps, file operation histories, trace information of system calls, etc.) collected when an incident occurs, and collectively stores them in chronological order for each related incident. For example, it automatically extracts communication packets and file operation histories that serve as traces of an attack, and efficiently manages them in preparation for a forensic investigation or an audit at a later date. In addition, the evidence management unit also realizes prevention of tampering with evidence data, encrypted storage, access authority management, and the like. Specifically, the evidence management unit drives a dedicated neural network module for evidence data management. The evidence management unit receives a binary stream of petabyte-class unstructured log data and packet capture files as input data. The evidence management unit divides this binary stream into fixed-length chunks. The evidence management unit executes dimensional compression using an autoencoder for each chunk. The evidence management unit generates a compressed latent variable vector. The evidence management unit inputs this latent variable vector to a clustering engine based on cosine similarity. The evidence management unit groups data groups having similar features as the same incident cluster. The evidence management unit calculates an importance score for each cluster. The evidence management unit receives, for example, as an input, a tensor of a suspicious registry change history and an encrypted communication packet to the outside. The evidence management unit generates, as an output, a relevance link graph indicating that these data originate from the same malware infection process. The evidence management unit stores data in a time-series graph database based on this link graph. The evidence management unit applies a lossy compression algorithm to data having a low importance score to save storage capacity. The evidence management unit encrypts data having a high importance score using an AES 256-bit encryption algorithm. The evidence management unit stores the encrypted data in a redundant secure storage. The evidence management unit mathematically proves non-tampering by calculating a hash value of data and recording it in a blockchain network. The evidence management unit completely eliminates a manual data sorting work by a human forensic investigator. The evidence management unit mathematically proves relevance of data by an unconventional processing method of vector operation in a latent space. The evidence management unit exhibits an extremely high technical effect in use cases such as cybercrime investigation by law enforcement agencies and internal audits of enterprises. The evidence management unit dramatically improves consumption efficiency of storage resources. The evidence management unit shortens a required time for data search and extraction from several hours to several seconds.

The notification generation unit automatically generates a notification text to an administrator and an incident report based on information from the analysis unit and the incident response unit. A generative AI summarizes contents and an impact range of a detected threat, and generates a text that conveys them to the administrator in an easy-to-understand manner. For example, it automatically generates a specific notification text such as “A massive amount of external communication occurred in a terminal A in a time zone different from normal, and a suspicion of malware infection was detected.

The corresponding terminal is automatically isolated from a network, and evidence data is stored.” In addition, when a plurality of incidents occur simultaneously, it automatically evaluates an impact range and a priority, and generates a report including prioritization of responses. Specifically, the notification generation unit constructs a dedicated natural language generation pipeline. The notification generation unit receives a structured JSON array including a plurality of pieces of alert information as input data. The notification generation unit converts this JSON array into a natural language prompt character string. The notification generation unit inputs this prompt character string to a transformer model on a scale of billions of parameters. The notification generation unit autoregressively generates a natural language text sequence according to a context using a decoder layer of the transformer model. The notification generation unit receives, for example, as an input, data indicating port scan detection in a terminal group B. The notification generation unit generates, as an output, text data including a specific response procedure recommending that a port scan intended for lateral movement to an internal network is in progress in the terminal group B and a VLAN of a corresponding segment should be immediately isolated. The notification generation unit further inputs feature vectors of a plurality of incidents to a clustering algorithm. The notification generation unit groups incident groups in a multidimensional space using an algorithm such as K-means or DBSCAN. The notification generation unit calculates a Euclidean distance between a centroid vector of each group and a profile vector of an important asset. The notification generation unit assigns a high priority score to a group having a short distance. The notification generation unit dynamically rearranges an incident response queue in descending order of this priority score. The notification generation unit renders a comprehensive incident report in an HTML format based on this rearranged queue. The notification generation unit completely substitutes a triage work and a report creation work based on an empirical rule by a human operator. The notification generation unit optimizes resource allocation by a mathematical approach of distance calculation in a high-dimensional vector space. The notification generation unit is applied to use cases such as reduction of alert fatigue and prevention of response omission in a large-scale security operations center. The notification generation unit brings about clear technical effects of improving throughput of an incident response process and efficiently operating system resources.

The system optimization unit learns past detection results and feedback from an administrator, and automatically optimizes a detection model and a defensive rule. For example, when false positives frequently occur in a certain terminal, it learns a usage pattern specific to the terminal, and automatically adjusts a threshold to be regarded as normal thereafter. In addition, when a new attack method is discovered, it immediately updates the detection model based on information obtained from external threat intelligence, and reflects it in all terminals and all network devices. Specifically, the system optimization unit implements mechanisms of continuous learning and online learning inside the system. The system optimization unit receives a feedback input from the administrator as a binary correct label. The system optimization unit calculates a cross-entropy error between this correct label and a past inference result. The system optimization unit fine-tunes a weight parameter of a neural network by a backpropagation method using this error signal. The system optimization unit extracts a false positive event in a specific terminal as a multidimensional feature vector. The system optimization unit maps this feature vector to an input space of a support vector machine. The system optimization unit dynamically recalculates a non-linear decision boundary using a kernel trick. The system optimization unit automatically updates a threshold parameter for abnormality determination based on this recalculated decision boundary. The system optimization unit receives, for example, as an input, a feature tensor of frequent compilation processing and large-capacity file transfer in a developer terminal. The system optimization unit generates, as an output, a dedicated relaxed threshold matrix for this specific terminal profile. The system optimization unit vectorizes a new attack signature acquired from external threat intelligence. The system optimization unit adds this vector to a weight matrix of an existing detection model. The system optimization unit differentially distributes updated model parameters to agents of all terminals using federated learning technology. The system optimization unit completely substitutes manual parameter adjustment and patch application work by a human engineer. The system optimization unit executes mathematical processing of dynamic optimization of a decision boundary in a high-dimensional space. The system optimization unit is applied to use cases such as operation management of a large-scale enterprise network and automation of a managed security service. The system optimization unit continuously reduces a false positive rate of the system. The system optimization unit brings about clear technical effects of preventing obsolescence of a model and improving long-term reliability of a computer system.

Specific examples of prompt sentences to be read by a generative AI when implementing the present invention include “Analyze the following system logs and network traffic data, detect behaviors different from normal and signs of unknown attacks, and if there is an abnormality, summarize its contents and an estimated attack method.”, “Update an existing threat information database based on latest threat intelligence information collected from the outside, and generate a new attack signature and detection rule.”, “Organize evidence data of a detected incident in chronological order, and automatically generate an incident report for an administrator.”, “Analyze a correlation of abnormal communications occurring simultaneously in a plurality of terminals, and estimate an attack scenario.”, and the like. By using these prompt sentences, the generative AI realizes advanced automation and optimization of the entire system, and can fundamentally solve on-site problems such as the sophistication of cyberattacks, a shortage of security human resources, and an enormous log analysis burden. Specifically, the system internally includes a template engine that dynamically generates these prompt sentences. The system receives system logs and network traffic data as a multidimensional tensor as input data. The system encodes this multidimensional tensor into a natural language text sequence. The system inserts this text sequence into a placeholder of a prompt sentence. The system passes a completed prompt character string to an input layer of a large language model. The system calculates a dependency relationship between each word in a prompt using a self-attention mechanism of the large language model. The system receives, for example, as an input, a text that a process A opens port 4444. The system generates, as an output, a classification label indicating an attempt of a reverse shell connection by the process A and a score indicating critical importance. The system transfers this output to a subsequent incident response module. The system maximizes inference accuracy of the large language model using prompt engineering technology. The system adopts a few-shot prompting method of including several specific examples in a prompt. The system improves generalization performance for unknown attack patterns by this method. The system completely automates a series of processes from generation of a prompt to parsing of an inference result. The system eliminates a manual query input work by a human operator. The system executes an unconventional information extraction process combining natural language processing technology and a deep learning model. The system exhibits an extremely high technical effect in use cases such as complete unmanned operation of a security operations center and autonomization of incident response. The system optimizes calculation resources required for log analysis. The system dramatically improves accuracy and speed of threat detection.

### Implementation Steps

Step 1: Multidimensional Collection of Security-Related Data. An agent program installed on a terminal side and a centralized management module on a server side cooperate to collect, in real time or periodically, various security-related data generated in each terminal, such as a system log, an application log, a file access history, a USB device connection history, a process start/end history, a network interface communication history, a user authentication history, an administrator privilege operation history, a browser access history, an email transmission/reception history, an external storage usage history, a VPN connection history, and a remote desktop connection history. Furthermore, on the server side, a traffic log, flow information, packet capture data, an external communication destination IP address, a port number, a communication protocol, a communication amount, geographical information of a communication destination, a DNS query history, an API access log of a cloud service, a usage history of an external storage service, an authentication/operation history of a SaaS application, and the like from network devices are collected, and these data are centrally managed on the server side and integrated with the data transmitted from the terminal side. Specifically, this step executes a data collection process in parallel as a plurality of asynchronous threads. This step utilizes a kernel driver deeply integrated into an operating system layer of the terminal. This step directly hooks a hardware interrupt and a system call via this kernel driver. This step parses acquired raw data from a binary format into a structured JSON format. This step accumulates this JSON data in a buffer area on a memory. This step batch-processes the data in the buffer at regular time intervals and converts the data into a multidimensional numerical vector. This step one-hot encodes, for example, a vendor ID and a product ID of a USB device as categorical variables. This step logarithmically transforms and normalizes a file access size and the number of communication bytes. This step combines these converted numerical values to generate, for example, a 256-dimensional feature vector. This step transmits this feature vector to the server via an encrypted TLS session. This step utilizes DPDK, which is a high-speed packet processing framework, on the server side. This step bypasses a network stack of a kernel by this framework. This step directly processes traffic data of several gigabits per second in a user space. This step extracts a source IP address and a destination port number from a packet header. This step maps this extracted data to a 32-dimensional embedding vector space. This step combines the feature vector from the terminal and the embedding vector from the network using a time stamp as a key. This step generates, for example, a 1024-dimensional integrated tensor by this combining process. This step treats data as coordinate points in a high-dimensional space, unlike a conventional simple log transfer process. This step improves inference accuracy of a subsequent AI model by this unconventional data processing method. This step is applied to use cases such as monitoring of a large-scale corporate network and traffic analysis of a cloud data center. This step brings about clear technical effects of speeding up data processing and saving a communication band.
Step 2: Abnormality Detection and Correlation Analysis by Generative AI. An analysis unit on the server side and a lightweight AI model on the terminal side analyze the collected massive amount of security-related data using a generative AI. The generative AI learns past normal communication patterns, user behavior patterns, normal operation histories for each terminal, usage tendencies for each business system, and the like from a large amount of data, and immediately detects an abnormality when, for example, a massive file transfer or external communication occurs late at night in a terminal that frequently accesses a specific business system during the day on weekdays. In addition, it analyzes correlations among a plurality of log data, and detects, with high accuracy, signs of complex attack scenarios such as simultaneous logins from a plurality of terminals by the same user, continuous occurrences of an attempt of privilege escalation and external communication in a short time, and suspicious communications occurring simultaneously at a plurality of bases. A specific example of a prompt sentence to be read by the generative AI is “Analyze the following system logs and network traffic data, detect behaviors different from normal and signs of unknown attacks, and if there is an abnormality, summarize its content and an estimated attack method.” Specifically, the analysis unit tokenizes the collected raw log data using natural language processing technology. The analysis unit converts the tokenized data into a fixed-length numerical vector. The analysis unit configures this numerical vector as an input tensor of a large language model. The input tensor has a three-dimensional structure of a batch size, a sequence length, and an embedding dimension. The analysis unit executes normalization of a time stamp as preprocessing of input data. The analysis unit encodes an IP address as a categorical variable. The analysis unit inputs these preprocessed data into a transformer model equipped with a self-attention mechanism. The transformer model has a multi-layer encoder block. The transformer model calculates temporal and spatial dependencies among respective log entries. The transformer model combines a context vector of the input prompt sentence and a vector representation of the log data. The transformer model non-linearly transforms the combined vector in a high-dimensional space. The transformer model calculates an abnormality score for each log entry as an output. The abnormality score is a floating-point number in a range from zero to one. The transformer model outputs an abnormality label when the abnormality score exceeds a preset threshold value. The transformer model outputs an attention weight distribution indicating a factor of the abnormality. The transformer model generates the estimated attack method as natural language text data. The analysis unit transmits the output abnormality score and text data to a subsequent incident response unit. The incident response unit determines a priority of a defensive action based on the received abnormality score. The incident response unit executes an automatic blocking script according to the priority. The system uses such a vector operation in a high-dimensional space. The system identifies an unknown attack pattern that cannot be discovered by conventional manual rule-based detection. The system dramatically reduces a false positive rate. The system dramatically improves a processing speed of a security monitoring operation. The system is applied to a mission-critical environment such as an accounting system network of a financial institution or a control system network of a large-scale manufacturing industry. The system protects information assets from advanced cyberattacks in these environments. The system can also adopt an alternative configuration that analyzes a communication topology among terminals using a graph neural network. The system further improves detection accuracy of a lateral movement attack by this alternative configuration.
Step 3: Automatic Collection and Analysis of External Threat Intelligence. A threat information update unit automatically collects latest attack methods, malware information, zero-day vulnerability information, targeted attack tendencies, attack warning information on the dark web, security-related information on SNS, and the like from an external threat intelligence source, extracts and summarizes useful information using a generative AI, and dynamically updates a threat information database. For example, it acquires new vulnerability information from a vulnerability information sharing platform, extracts characteristics of an attack code and abuse cases to reflect them in the database, or automatically analyzes behavior information of a new type of malware shared in a security community to generate a signature. A specific example of a prompt sentence to be read by the generative AI is “Update the existing threat information database based on the latest threat intelligence information collected from the outside, and generate a new attack signature and detection rule.” Specifically, the threat information update unit extracts unstructured text data acquired from an external source using a scraping technology. The threat information update unit divides the extracted text data into sentence units. The threat information update unit inputs the divided text data into a pre-trained language model. The language model adopts an encoder architecture that understands a bidirectional context. The language model extracts a named entity from the input text. The language model identifies entities such as a hash value of malware, a malicious IP address, and a vulnerability identifier. The language model extracts relationships among the identified entities. The language model structures the extracted relationships in a format of a knowledge graph. The language model converts the structured data into a multidimensional embedding vector. The threat information update unit stores the generated embedding vector in a vector database. The threat information update unit calculates a cosine similarity in a vector space every time new threat information is input. The threat information update unit identifies existing information having a similarity equal to or greater than a certain value. The threat information update unit merges the identified existing information and the new information. The threat information update unit automatically generates a new detection signature based on the merged information. The threat information update unit distributes the generated signature to an agent of each terminal and a network device. The system minimizes a time lag from collection to application of threat information by this automated pipeline. The system completely eliminates manual report decoding work by a security analyst. The system dramatically speeds up an initial response of defense against a zero-day attack. The system is extremely effective in an organization that is likely to be a target of an advanced persistent threat backed by a nation, such as a government agency or a large-scale telecommunications carrier. The system can also adopt a variation configuration in which a multilingual translation model is arranged in a preceding stage. By this variation configuration, the system can analyze threat information in a non-English speaking area shared in an overseas underground forum in real time and reflect it in a defensive rule.
Step 4: Execution of Automatic Defensive Measure and Incident Response. An incident response unit automatically executes a defensive measure against an abnormality or a threat detected by an analysis unit. For example, when a malware infection is detected on a terminal side, a terminal agent automatically disables a network interface, and the incident response unit on a server side transmits a detailed notification to an administrator and stores evidence data in a secure storage. On the server side, traffic of the entire network is monitored, and communication from a suspicious IP address is immediately blocked by a firewall, or when spread of infection to a plurality of terminals is suspected, the corresponding terminal group is simultaneously isolated from the network. When an abnormality in API access is detected on a cloud service, invalidation of a corresponding API key and blocking of an access source IP are automatically executed, and at the same time, a detailed incident report is automatically generated and transmitted to the administrator. Specifically, the incident response unit determines an optimal defensive action based on an abnormality score and a threat category received from the analysis unit. The incident response unit includes a decision-making agent based on a reinforcement learning algorithm. The decision-making agent observes a current network state as a state vector. The decision-making agent selects an action that maximizes an expected reward from a set of possible defensive actions. The decision-making agent dynamically combines actions such as isolation of a malware-infected terminal, blocking of a specific port, and invalidation of an API key. The incident response unit converts the selected action into a specific control command. The incident response unit transmits the control command to a controller of a software-defined network via an API. The controller immediately rewrites an access control list of a network device based on the received command. The incident response unit transmits a signal for forced termination of a process to the terminal agent. The terminal agent stops the corresponding process at a kernel level of an operating system. The incident response unit collects execution results of these defensive measures as status codes. The incident response unit feeds back the execution results to a reward function of the decision-making agent. The system continuously improves accuracy and efficiency of the defensive action by this closed-loop control. The system realizes an autonomous incident response without human intervention. The system enables defense deployment in units of milliseconds exceeding a progress speed of an attack. The system is an indispensable technology in an environment where a momentary service stoppage causes enormous economic loss, such as an e-commerce platform or an online banking system. The system can also adopt an alternative configuration provided with a semi-automatic mode that requests approval of the administrator before executing the defensive action. By this alternative configuration, the system supports stepwise introduction of automation while minimizing a risk of business stoppage due to a false positive.
Step 5: Automatic Organization and Preservation of Evidence Data. An evidence management unit automatically classifies and organizes evidence data (a log at the time of detection, a communication packet, a system state, a user operation history, a memory dump, a file operation history, trace information of a system call, etc.) collected when an incident occurs, and collectively stores the evidence data in chronological order for each related incident. It automatically extracts a communication packet and a file operation history that become traces of an attack, and efficiently manages them in preparation for a forensic investigation or an audit at a later date. It also realizes prevention of falsification, encrypted preservation, and access authority management of the evidence data. Specifically, the evidence management unit receives a trigger signal from an incident response unit. The evidence management unit acquires a system memory dump for a certain period before and after the time when the trigger signal is received. The evidence management unit extracts full capture data of a network packet. The evidence management unit divides these unstructured binary data into chunk units. The evidence management unit applies a cryptographic hash function to each chunk. The evidence management unit records the generated hash value in a distributed ledger of a blockchain network. The evidence management unit thereby mathematically proves completeness and non-falsification of the evidence data. The evidence management unit inputs the collected log data into a clustering algorithm. The clustering algorithm groups the data based on proximity of time stamps and similarity of feature vectors. The evidence management unit stores the grouped data in a container for each incident. The evidence management unit assigns metadata to each container. The evidence management unit hierarchically stores the container including the metadata in an object storage. The evidence management unit executes life cycle management for automatically migrating data from a hot storage to a cold storage according to an access frequency. The system optimizes a storage cost of a massive amount of evidence data by this advanced data management method. The system dramatically improves a data search speed during a forensic investigation. The system promptly provides legally valid digital evidence in an investigation by a law enforcement agency or a security audit by a third-party organization. The system is extremely useful in an environment where strict compliance requirements are demanded, such as an electronic medical record system of a medical institution or a basic resident register system of a government. The system can also adopt a variation configuration in which an anonymization module that automatically masks confidential information from the evidence data is added. By this variation configuration, the system realizes both privacy protection and incident analysis.
Step 6: Administrator Notification and Automatic Report Generation. A notification generation unit automatically generates a notification text and an incident report to an administrator based on information from an analysis unit and an incident response unit. A generative AI summarizes content and an impact range of a detected threat, and generates a text that conveys them to the administrator in an easy-to-understand manner. For example, it automatically generates a specific notification text such as “A massive external communication occurred in terminal A at an unusual time, and a suspicion of malware infection was detected. The corresponding terminal has been automatically isolated from the network, and evidence data has been preserved.” A specific example of a prompt sentence to be read by the generative AI is “Organize evidence data of a detected incident in chronological order, and automatically generate an incident report for an administrator.” Specifically, the notification generation unit acquires structured incident data from an evidence management unit. The notification generation unit formats the acquired data as an input prompt of a natural language generation model. The natural language generation model adopts a transformer-based decoder architecture. The natural language generation model extracts an important event from the input structured data. The natural language generation model logically configures the extracted event in chronological order. The natural language generation model executes an autoregressive text generation process that converts a technical term into a plain expression. The natural language generation model generates a human-readable incident report as an output. The notification generation unit evaluates an importance level of the generated report. The notification generation unit dynamically selects a notification channel according to the importance level. The notification generation unit transmits a push notification to a mobile terminal of the administrator when an urgency level is high. The notification generation unit transmits the report by email as a daily summary report when the urgency level is low. The notification generation unit embeds a secure hyperlink for accessing detailed data of the incident in the report. The system reduces work time required for report creation by a security administrator to zero by this automatic generation technology. The system shortens a delay from occurrence of an incident to information transmission to the administrator to the utmost limit. The system eliminates individual variations in report quality, and guarantees accurate information provision always at a certain level or higher. The system becomes a core technology that dramatically improves operational efficiency in a managed security service provider that monitors a large number of customer systems. The system can also adopt a variation configuration that automatically generates a report tailored to a native language of an administrator at each base of a global company using a multilingual generative model. By this variation configuration, the system supports construction of a prompt cross-border incident response system.
Step 7: System Optimization and Automatic Tuning. A system optimization unit learns past detection results and feedback from an administrator, and automatically optimizes a detection model and a defensive rule. For example, when a false positive frequently occurs in a certain terminal, it learns a usage pattern unique to the terminal, and automatically adjusts a threshold value to be regarded as normal thereafter. In addition, when a new attack method is discovered, it immediately updates the detection model based on information obtained from external threat intelligence, and reflects it in all terminals and all network devices. A specific example of a prompt sentence to be read by a generative AI is “Optimize a detection model and a defensive rule based on past detection results and administrator feedback.” Specifically, the system optimization unit collects a feedback input from the administrator as a binary label. The system optimization unit extracts log data determined to be a false positive. The system optimization unit adds the extracted data to a dataset for retraining. The system optimization unit fine-tunes a weight parameter of the detection model using an online learning algorithm. The system optimization unit updates the parameter in a direction of minimizing a loss function using a gradient descent method. The system optimization unit evaluates performance of the updated model using a dataset for verification. The system optimization unit seamlessly replaces the model in a production environment when performance improvement is confirmed. The system optimization unit adopts a federated learning technology in order to learn a unique usage pattern of each terminal. The system optimization unit aggregates only gradient information calculated locally on a terminal side to a server. The system optimization unit updates a global model using the aggregated gradient information. The system optimization unit distributes the updated global model to each terminal again. The system autonomously adapts the model to an environmental change and a new attack method by this continuous learning loop. Since the system does not transmit raw data on a network, it improves accuracy of the model while protecting privacy. The system completely eliminates an operational load of manual signature update and threshold adjustment. The system realizes scalable and secure operation in a smart city infrastructure or a large-scale factory network to which tens of thousands of IoT devices are connected. The system can also adopt a variation configuration that uses a Bayesian optimization algorithm for optimization of a hyperparameter. By this variation configuration, the system maximizes detection performance of the model most efficiently within limited computational resources.

### Specific Use Case

For example, when the system of the present invention is applied to a terminal group and a server group installed at a plurality of bases in an organization, and a business system using a cloud service, first, an agent program is introduced into each terminal, and various security-related data such as a system log, an application log, a file access history, a USB device connection history, a process start/end history, a network interface communication history, a user authentication history, an administrator privilege operation history, a browser access history, an email transmission/reception history, an external storage usage history, a VPN connection history, and a remote desktop connection history are collected in real time. On the server side, a traffic log, flow information, packet capture data, an external communication destination IP address, a port number, a communication protocol, a communication amount, geographical information of a communication destination, a DNS query history, an API access log of a cloud service, a usage history of an external storage service, an authentication/operation history of a SaaS application, and the like from network devices are centrally collected and integrated with the data transmitted from the terminal side. Specifically, the data collection unit is implemented as a lightweight daemon process resident in each terminal and server. The data collection unit sets a hook in a kernel space of an operating system. The data collection unit acquires high-resolution event data with low overhead by directly intercepting a system call. The data collection unit temporarily stores the acquired raw data in a ring buffer on a memory. The data collection unit serializes the data using asynchronous IO. The data collection unit transmits the serialized data to a central stream processing infrastructure via a message queuing protocol. The stream processing infrastructure adopts a distributed publish-subscribe model. The stream processing infrastructure receives millions of event messages per second without loss. The stream processing infrastructure executes schema verification of the received message. The stream processing infrastructure performs synchronization processing of a time stamp and interpolation processing of a missing value. The stream processing infrastructure combines terminal-side data and server-side data using a common identifier. The stream processing infrastructure reconstructs the combined data as a multidimensional time-series tensor. The system eliminates data silos in a heterogeneous environment by this robust data pipeline. The system realizes real-time data integration while minimizing consumption of a network band. The system provides end-to-end visibility in an internal network of a multinational company expanding globally or a multi-cloud environment straddling a plurality of cloud providers. The system can also adopt a variation configuration in which an edge computing node is arranged at each base to perform primary data aggregation and filtering locally. By this variation configuration, the system significantly reduces communication traffic to a central server and optimizes a communication cost of a wide area network.

In such a configuration, for example, when a massive file transfer occurs outside normal business hours at a terminal in a certain base, and at the same time, communication to the same external IP address rapidly increases in a plurality of terminals, the analysis unit using the generative AI immediately detects these abnormalities because it has already learned past normal communication patterns, user behavior patterns, normal operation histories for each terminal, usage tendencies for each business system, and the like. Furthermore, the generative AI analyzes correlations among a plurality of log data, and detects, with high accuracy, signs of complex attack scenarios such as simultaneous logins from a plurality of terminals by the same user, continuous occurrences of privilege escalation and external communication in a short time, and suspicious communications occurring simultaneously and frequently at a plurality of bases. Specifically, the analysis unit inputs an integrated time-series tensor to a graph neural network. The graph neural network constructs a dynamic graph structure with terminals and servers as nodes and communication sessions as edges. The graph neural network allocates attribute information such as a CPU usage rate, the number of process startups, and a login state as a feature vector of each node. The graph neural network executes a message passing algorithm. The graph neural network exchanges feature information between adjacent nodes and updates a latent representation of each node. The analysis unit calculates an abnormality score for a snapshot of the entire graph using the updated latent representation. The analysis unit quantifies a temporal abnormality of a massive file transfer outside normal business hours and a spatial abnormality of communication from a plurality of terminals to the same IP as a degree of deviation from a cluster in a high-dimensional space. The analysis unit calculates this degree of deviation using a Mahalanobis distance. When the calculated distance exceeds a dynamically set threshold, the analysis unit determines that a complex attack scenario is progressing. By this graph-based correlation analysis, the system visualizes a sophisticated distributed attack and lateral movement that are missed by single log monitoring. The system prevents over-detection of alerts and extracts only incidents that become true threats. The system contains an advanced targeted attack and an intra-organizational infection spread of ransomware at an early stage. The system constructs a strong security boundary in a research and development department handling confidential information and a supply chain network connected to a large number of outsourced companies. The system can also adopt a variation configuration in which a recurrent neural network is used in combination for predicting time-series data, and a residual between a predicted value and an actual measurement value is added to the abnormality score. With this variation configuration, the system further improves detection accuracy for temporal fluctuation patterns.

In addition, by an automatic collection and analysis function of external threat intelligence, for example, characteristics of ransomware newly discovered around the world, methods of targeted attacks aimed at specific industries, and abuse cases of zero-day vulnerabilities are automatically collected, and the generative AI extracts and summarizes useful information using natural language processing technology to dynamically update the threat information database. This makes it possible to quickly respond to unknown attacks and new types of malware. Specifically, the threat information update unit inputs unstructured data acquired from open source intelligence and commercial threat feeds to a large language model having a zero-shot learning capability. The large language model classifies tactics, techniques, and procedures of an attacker from input text without prior fine-tuning. The large language model converts a classification result into a format of a standardized cyber threat intelligence description language. The threat information update unit extracts indicators of compromise such as a file hash of malware, a communication destination domain, and a registry change pattern from the converted structured data. The threat information update unit maps the extracted indicators of compromise to a multidimensional vector space. The threat information update unit calculates a cosine similarity with a vector group in the existing threat information database. The threat information update unit adds a new threat vector having a low similarity to the database. The threat information update unit automatically generates a custom detection rule for an endpoint detection and response system based on the added threat vector. By this combination of advanced natural language understanding and vector search, the system completely bypasses a process of decoding and setting by a human. The system reflects the latest threat information generated around the world in a defense system of its own organization within a few minutes. The system dramatically enhances defense capability against polymorphic malware and fileless attacks that cannot be prevented by conventional signature-based antiviruses. The system establishes a proactive defense system in an operation infrastructure of a cloud service provider or a large-scale e-commerce site facing new attack methods every day. The system can also adopt a variation configuration in which multilingual threat information is integrated into a single vector space using a cross-lingual model. With this variation configuration, the system immediately applies early threat signs localized to a specific region or language area to a global defense network.

When an abnormality or a threat is detected, the incident response unit automatically executes a defensive measure. For example, when a malware infection is detected on the terminal side, the terminal agent automatically disables a network interface, the incident response unit on the server side transmits a detailed notification to the administrator, and saves evidence data (a log at the time of detection, a communication packet, a system state, a user operation history, a memory dump, a file operation history, trace information of a system call, etc.) in a secure storage. On the server side, traffic of the entire network is monitored, and communication from a suspicious IP address is immediately blocked by a firewall, or when an infection spread to a plurality of terminals is suspected, the corresponding terminal group is simultaneously isolated from the network. When an abnormality in API access is detected on a cloud service, invalidation of a corresponding API key and blocking of an access source IP are automatically executed, and at the same time, a detailed incident report is automatically generated and transmitted to the administrator. Specifically, the incident response unit receives an abnormality score and a threat classification label output from the analysis unit. The incident response unit evaluates a Markov decision process, which is a predefined state transition model, based on the received label. The incident response unit calculates a transition destination state with the highest expected reward from the current system state. The incident response unit dynamically generates a specific control script based on a calculation result. The incident response unit issues a down command at a physical layer level of the network interface to the terminal agent. The incident response unit simultaneously issues a command to acquire a complete dump image of a kernel memory space of an operating system. The incident response unit encrypts the acquired dump image and transfers it to a secure object storage. The incident response unit cooperates with a controller of a software-defined network and adds the suspicious IP address to a dynamic access control list. The incident response unit calls an identity management API of a cloud environment and immediately revokes an authority of the API key suspected of being leaked. The system autonomously executes these complex orchestrations with a latency in milliseconds. The system physically and logically prevents an expansion of damage due to a human judgment delay. The system dramatically shortens a mean time to repair required for incident response and ensures business continuity. The system functions as a fail-safe mechanism that localizes damage in a critical infrastructure requiring non-stop operation and an administrative system managing a massive amount of personal information. The system can also adopt a variation configuration in which an infected terminal is dynamically moved to a virtual network segment for isolation using micro-segmentation technology. With this variation configuration, the system enables detailed dynamic analysis of malware in an isolated environment while minimizing an impact on business.

An evidence management unit automatically classifies and organizes evidence data collected when an incident occurs, collectively saves the evidence data in chronological order for each related incident, automatically extracts a communication packet and a file operation history that become traces of an attack, and efficiently manages them in preparation for a forensic investigation and an audit at a later date. A notification generation unit automatically generates a notification text and an incident report to the administrator based on information from the analysis unit and the incident response unit, and generates a specific notification text such as, for example, “A massive amount of external communication occurred at terminal A in a time zone different from normal, and a suspicion of malware infection was detected. The corresponding terminal has been automatically isolated from the network, and evidence data has been saved.” Specifically, the evidence management unit inputs the collected evidence data in a wide variety of formats to a normalization pipeline. The evidence management unit inserts the normalized data into a time-series database. The evidence management unit assigns a metadata tag such as an incident identifier, a threat level, and a related terminal IP to each data record. The evidence management unit constructs an inverted index to enable high-speed full-text search. The evidence management unit embeds a digital watermark in the saved data to guarantee the origin and integrity of the data. The notification generation unit query-extracts a data set related to the corresponding incident from the time-series database. The notification generation unit inputs the extracted data set to a natural language generation model equipped with a multi-head attention mechanism. The natural language generation model calculates an importance of each event in the data set as an attention weight. The natural language generation model preferentially extracts an event with high importance, and autoregressively generates a text sequence of a coherent natural language. The notification generation unit maps the generated text to a report template in a JSON format. The notification generation unit push-delivers the completed report to a dashboard of the administrator via a secure communication protocol. By this series of processes, the system automatically extracts intelligence that can be intuitively understood by a human from a massive amount of raw data. The system significantly reduces a cognitive load on an analyst in a security operations center. The system shortens a lead time from grasping the whole picture of an incident to reporting from several hours to several seconds. The system becomes a foundation for reliably satisfying compliance requirements in financial institutions and listed companies where strict incident reporting obligations are imposed. The system can also adopt a variation configuration in which the generated report is input to a speech synthesis engine, and in an emergency, an alert is issued to a telephone of the administrator by an automatic voice call. With this variation configuration, the system completely prevents overlooking of a serious incident late at night or on a holiday.

A system optimization unit learns past detection results and feedback from the administrator, and automatically optimizes a detection model and a defensive rule. For example, when false detection frequently occurs in a certain terminal, a usage pattern specific to the terminal is learned, and thereafter, a threshold value considered normal is automatically adjusted. In addition, when a new attack method is discovered, the detection model is immediately updated based on information obtained from external threat intelligence, and is reflected in all terminals and all network devices. Specifically, the system optimization unit collects implicit and explicit feedback signals from a dashboard operation history of the administrator. The system optimization unit labels an event in which an alert is ignored or manually closed as negative example data of false detection. The system optimization unit recalculates a decision boundary of an abnormality detection model using this negative example data. The system optimization unit executes margin adjustment of a support vector machine and backpropagation based on a cross-entropy error of a neural network. The system optimization unit dynamically updates a local threshold parameter for a specific terminal or user group. The system optimization unit acquires a new attack feature vector extracted from the external threat intelligence. The system optimization unit executes a transfer learning process for integrating this new vector into a weight matrix of an existing model. The system optimization unit serializes the updated model parameter and broadcasts it to all edge nodes through a secure distribution channel. The edge node applies the received parameter to an inference engine on a memory by hot swapping. The system self-evolves the detection accuracy of the system by this continuous integration and continuous deployment pipeline. The system brings about a learning effect in which a false positive rate gradually decreases and a true positive rate improves as an operation period becomes longer. The system makes it possible to always maintain the latest and optimal defense state even in an organization without a security expert. The system realizes flexible and robust security operation in an agile development environment where a system configuration is frequently changed and a campus network of a university where various devices are connected. The system can also adopt a variation configuration in which a threshold adjustment process itself is automated using reinforcement learning, and a tradeoff between a false positive rate and a false negative rate is autonomously optimized. With this variation configuration, the system realizes fully autonomous tuning that completely eliminates human intervention.

Specific examples of prompt sentences to be read by the generative AI include “Analyze the following system logs and network traffic data, detect behaviors different from normal and signs of unknown attacks, and if there is an abnormality, summarize its content and an estimated attack method.”, “Update the existing threat information database based on the latest threat intelligence information collected from the outside, and generate a new attack signature and detection rule.”, “Organize evidence data of detected incidents in chronological order, and automatically generate an incident report for an administrator.”, and “Analyze a correlation of abnormal communications occurring simultaneously and frequently in a plurality of terminals, and estimate an attack scenario.” Specifically, the system includes a prompt engineering module that dynamically constructs these prompt sentences. The prompt engineering module optimizes a context window of a prompt according to the size and type of input data. The prompt engineering module embeds a system log and traffic data in the prompt as structured text in a JSON format. The prompt engineering module adopts a few-shot prompting method in order to improve inference accuracy of the large language model. The prompt engineering module adds an analysis example of a past similar incident to the beginning of the prompt as an example. The prompt engineering module applies chain-of-thought prompting that causes the model to output a thinking process stepwise. The system inputs the generated prompt to a tokenizer and converts it into an array of integer IDs that can be processed by the model. The system inputs this array to the large language model and acquires a text sequence of an inference result. The system extracts a necessary parameter and a summary sentence from the output text using a regular expression. By this advanced prompt control, the system causes a general-purpose language model to function as a highly accurate expert system specialized for a specific security task. The system suppresses hallucination of the model and guarantees accurate analysis results and report generation based on facts. The system makes it possible even for a young operator without complex log analysis skills to exhibit an incident response capability equivalent to that of a skilled analyst. The system provides extremely high value as a managed service infrastructure for mid-sized and small-to-medium-sized enterprises where a shortage of security human resources is serious. The system can also adopt a variation configuration in which a prompt template is dynamically acquired from an external knowledge base, and the prompt itself is automatically updated in accordance with the latest attack trend. With this variation configuration, the system further enhances adaptability of the language model to unknown threats.

By such use cases, the system of the present invention can fundamentally solve on-site problems such as sophistication of cyberattacks, a shortage of security human resources, and a massive log analysis burden, and dramatically improve a security level of the entire organization. Specifically, the system completely automates a series of security operation processes of data collection, abnormality detection, threat intelligence integration, execution of defensive measures, evidence management, and report generation using high-dimensional vector operations and deep learning models. The system replaces inefficient mental processes such as conventional manual visual confirmation of logs and rule-based signature matching with parallel tensor operations inside a computer. Thereby, the system dramatically shortens a mean time to detect and a mean time to respond to an incident from several days to the order of several milliseconds. The system filters noise of unnecessary alerts due to false detection by a statistical machine learning method, and prevents waste of computational resources and human resources of a security operations center. The system self-propagatingly improves defense performance of the system over time by running an autonomous model re-learning and parameter optimization loop. By these technical improvements, the system maximizes return on investment in cybersecurity operations. The system mathematically and physically minimizes a business suspension risk due to ransomware and a damage compensation risk due to information leakage. The system functions as an indispensable infrastructure supporting business continuity in all companies promoting digital transformation, particularly financial institutions holding a massive amount of customer data, medical institutions where non-stop operation is an absolute condition, and advanced manufacturing industries handling intellectual property. The system can also adopt a variation configuration in which it is deployed on a cloud-native container architecture and an inference node is auto-scaled according to an increase or decrease in traffic. With this variation configuration, the system maintains stable detection and defense capabilities without degrading performance even against a sudden large-scale DDoS attack or a rapid traffic spike.

(Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

Embodiments for carrying out the present invention will be described more specifically and in detail. The system of the present invention comprehensively collects and analyzes all information generated at an operation site of a data center, and uses a generative AI as an essential component, thereby realizing real-time and autonomous detection, defense, recovery, and optimization against complex and diverse risks that have been difficult to deal with by conventional human hands or rule bases. Specifically, the system constructs a digital twin infrastructure that integrally processes multidimensional time-series data generated from both a physical infrastructure and a virtual infrastructure in the data center. The system acquires streaming data at a high frequency from a sensor node and a software agent arranged in each device. The system caches the acquired data in an in-memory database to enable data access with ultra-low latency. The system inputs this integrated data set to a large-scale multimodal neural network based on a transformer architecture. The neural network projects data of different modalities such as a text log, numerical metrics, and image data to a common latent space vector. The neural network learns a complex nonlinear correlation among modalities using a cross-attention mechanism. The system utilizes this advanced vector space representation to capture, at an early stage, a sign of a minute abnormality that cannot be discriminated from a single data source. The system breaks through limitations of siloed monitoring tools based on conventional alert threshold setting, and realizes holistic state monitoring of the entire data center. The system distinguishes between a physical failure sign of hardware and a logical sign of a cyberattack, and triggers an optimal autonomous recovery process for each. Thereby, the system brings about complex technical effects of optimizing power usage effectiveness of the data center, minimizing downtime, and dramatically reducing operation personnel. The system is applied to a mission-critical facility requiring extremely high availability and security, such as an ultra-large-scale cloud data center operated by a hyperscaler and an edge computing base of a telecommunications carrier. The system can also adopt a variation configuration in which cooling efficiency of an air conditioning facility and a calculation load of a server are dynamically balanced using a reinforcement learning agent. With this variation configuration, the system autonomously minimizes power consumption of the entire data center and directly contributes to promotion of green IT.

First, the data collection unit collects, in real time, operational data and security-related data generated from all IT devices and physical facilities in the data center, such as servers, storage devices, network devices, virtualization infrastructures, cloud cooperation environments, operation terminals, power supply facilities, air conditioning facilities, surveillance cameras, and access control systems. For example, from a server, it collects a CPU usage rate, a memory usage amount, a disk I/O, a process start/end log, an administrator privilege operation history, a system event log, a user authentication history, a file access history, an OS patch application history, a remote access history, a service start/stop history, an execution history of a backup job, an application log, a crash dump, traffic statistics of a network interface, and the like. For example, from a storage device, it collects an access log, an error occurrence history, a capacity usage status, a RAID rebuild history, disk failure sign data, SMART information, a snapshot acquisition history, a state of inter-storage replication, a firmware update history of a storage controller, and the like. For example, from a network device, it collects a traffic log, a communication destination IP address, a port number, a communication protocol, a communication amount, a blocked/permitted communication history, an ARP table change, abnormal detection of a MAC address, alert information of an IDS/IPS, a routing table change history, a VPN connection history, a QoS setting change history, a firmware update history of the network device, and the like. For example, from a virtualization infrastructure, it collects a virtual machine start/stop history, a resource allocation change history, a live migration history, a virtual switch setting change history, traffic information of a virtual network, a virtual machine snapshot acquisition history, a virtual disk expansion/reduction history, an administrator operation history of the virtualization infrastructure, and the like. For example, from a cloud cooperation environment, it collects an API access log, an authentication/operation history of external cooperation, a usage history of a cloud storage, a start/stop/snapshot acquisition history of a virtual machine on a cloud, a cloud service authority change history, a cloud API key issuance/revocation history, a security group setting change history on a cloud, and the like. For example, from an operation terminal, it collects a login history, a file transfer history, a USB device connection history, a remote desktop connection history, an administrator privilege escalation history, a terminal network setting change history, a terminal virus scan history, a terminal software installation history, and the like. For example, from a power supply facility, it collects power consumption data, an abnormal voltage detection history, a battery state of a UPS, a power supply switching history, a generator startup history, a redundant configuration state of a power supply system, and the like. For example, from an air conditioning facility, it collects temperature sensor data, an operating status of a cooling device, an air conditioning setting change history, an abnormal temperature alert history, humidity sensor data, an air conditioning filter replacement history, and the like. For example, from a surveillance camera, it collects video data, a motion detection log, a camera setting change history, a recorded data save/delete history, and the like. For example, from an access control system, it collects an access log, an IC card authentication history, a biometric authentication history, an alarm occurrence history, a door opening/closing history, and the like. These data are transmitted to a centralized management module on the server side in real time or periodically, and are integrally managed. Specifically, the data collection unit includes a multi-protocol parser that interprets various protocols. The data collection unit applies an agentless monitoring method and an agent-based monitoring method in a hybrid manner. The data collection unit converts an analog sensor signal from a physical device into digital time-series data via an AD converter. The data collection unit converts an uncompressed video stream from a surveillance camera into an image tensor in units of frames. The data collection unit executes a timestamp synchronization process for each data stream. The data collection unit complements a missing value using a spline interpolation algorithm in order to map data having different sampling rates to a common time axis. The data collection unit applies downsampling to normal metrics data generated at a high frequency to compress a data volume. The data collection unit ingests the preprocessed heterogeneous data into a key-value store type distributed database. By this comprehensive sensor fusion technology, the system combines a logical event in a cyber space and an environmental change in a physical space on a single data plane. The system prevents omission of data collection and maximizes a dimension of a feature space in subsequent AI analysis. The system makes it possible to monitor both logical destruction due to a cyberattack and physical destruction due to air conditioning stoppage or power disconnection on the same infrastructure in the operation of the data center. The system comprehensively protects IT infrastructures of all generations, from a legacy environment where a mainframe of a financial institution operates to the latest container orchestration infrastructure. The system can also adopt a variation configuration in which a lightweight autoencoder is executed on the edge device side, and only data deviating from a normal pattern is transmitted to the central server. With this variation configuration, the system guarantees collection of important abnormal data while dramatically reducing consumption of a network bandwidth.

Next, the analysis unit analyzes the collected massive amount of data multidimensionally and chronologically using the generative AI as an essential component. The generative AI utilizes a combination of a deep learning model, a time-series analysis model, a self-supervised learning model, a large language model, a generative adversarial network, and the like. For example, it learns past normal operational patterns, normal operation tendencies for each device, traffic tendencies of the entire data center, operation histories for each user, external threat intelligence information, and the like from a massive amount of data, and detects, in real time and with high accuracy, behaviors different from normal, correlation abnormalities among a plurality of data sources, signs of known or unknown cyberattacks, signs of failures, operational errors, environmental abnormalities, and the like. For example, it detects complex abnormal signs such as massive external communication during the day deviating from a normal pattern in which backup jobs are concentrated at night, a rapid increase in an error occurrence frequency and a rise in a temperature sensor value in a storage device, an abnormal increase in live migration of a virtual machine, a rapid increase in access to a normally unused cloud API from an operation terminal, a concentration of blocked communication to a specific IP address in a network device, suspicious process startups occurring simultaneously and frequently in a plurality of servers, unnatural escalation or continuous operation of administrator privileges, a suspicious API call or massive data transfer to an external storage in a cloud environment, a server shutdown occurring simultaneously with a UPS battery abnormality, an abnormality in an access log occurring simultaneously with a surveillance camera setting change, and a correlation between an abnormal temperature alert of an air conditioning facility and occurrence of a high load on a server. Specifically, the analysis unit inputs the integrated multidimensional data to a variational autoencoder. The variational autoencoder has an encoder network that maps input data to a probability distribution in a low-dimensional latent space. The variational autoencoder has a decoder network that reconstructs original data from the latent space. The analysis unit calculates a reconstruction error between the input data and the reconstructed data. The analysis unit uses this reconstruction error as an abnormality score. The analysis unit learns a distribution of normal operational data using a generative adversarial network. A discriminator of the generative adversarial network outputs a probability value for discriminating whether observed data is generated from a normal distribution or arises from an abnormal state. The analysis unit integrates outputs from these plurality of deep learning models using an ensemble learning algorithm, and makes a final abnormality determination. When it is determined to be an abnormality, the analysis unit infers a root cause of the abnormality using a large language model. The large language model receives each sensor value and log entry at the time of occurrence of the abnormality as a prompt, and outputs a chain of causal relationships in a natural language based on past learning data. By this advanced multivariate analysis, the system identifies a complex attack scenario straddling a cyber space and a physical space and a sign of a chain hardware failure, which can never be discovered by single threshold monitoring. The system detects, with high accuracy, an unknown zero-day attack and sophisticated data exfiltration by an internal crime while suppressing false detection to the utmost limit. The system realizes a paradigm shift from reactive troubleshooting to proactive predictive maintenance and threat hunting in operation management of a data center. The system is an essential technology in an environment where a slight abnormality relates to human life or national security, such as a data center handling important government secrets and a back-end system of an autonomous vehicle. The system can also adopt a variation configuration in which a long short-term memory network is used for analyzing time-series data, a future sensor value is predicted from a past sequence, and a degree of deviation from a predicted value is used as an abnormality score. With this variation configuration, the system further improves detection accuracy in an environment accompanied by periodic load fluctuations.

Furthermore, the analysis unit automatically collects and analyzes external threat intelligence information, analyzes, for example, signatures of new malware, methods of targeted attacks, exploitation cases of zero-day vulnerabilities, suspicious IP address lists, industry-specific attack trends, attack warning information on the dark web, security-related information on SNS, published vulnerability information, attack campaign information shared in security communities, and the like, and updates the threat information database at any time. This makes it possible to quickly respond to unknown attacks and new types of malware. Specifically, the analysis unit continuously collects unstructured text data from various external sources using a web crawler. The analysis unit applies a topic modeling algorithm to the collected text data. The analysis unit extracts hidden topics related to cyberattacks from a text group using a latent Dirichlet allocation method. The analysis unit inputs the text including the extracted topics into a pre-trained transformer model. The transformer model executes sentiment analysis and calculates a threat level of each piece of information as a continuous value score from zero to one. The analysis unit extracts specific indicators of compromise such as an attacker's IP address, a hash value of malware, and an exploited port number from information whose threat level score exceeds a threshold, using a named entity recognition technology. The analysis unit maps the extracted indicators of compromise to an ontology-based knowledge graph. The analysis unit executes a link prediction algorithm between nodes on the graph to infer an undiscovered related threat infrastructure. The analysis unit inserts a latest threat vector including an inference result into the threat information database. The system completely automates a process in which a human analyst manually collects and analyzes information by this series of natural language processing pipelines. The system makes it possible to dynamically rewrite a defensive rule of its own organization at the moment when information on a zero-day exploit traded on the dark web is detected. The system secures a time advantage of preparing a defensive posture before an attacker starts a new campaign. The system constructs a proactive cyber defense network in multinational corporations and financial institutions that develop business globally and are always targets of various cyberattacks. The system can also adopt a variation configuration in which an image recognition model is used in combination to extract a setting screen of an attack tool or a fragment of a source code from a screenshot image posted on a hacker forum by optical character recognition. The system captures even concealed threat information that is not textified without omission by this variation configuration.

The incident response unit automatically executes a defensive measure or a recovery measure against the abnormality, the threat, or the sign of failure detected by the analysis unit. For example, when a suspicion of malware infection is detected in a server, the corresponding server is automatically separated from the network, an administrator is notified, and evidence data (a log at the time of detection, a communication packet, a system state, a user operation history, etc.) is preserved. For example, when a sign of failure is detected in a storage device, access to the corresponding device is restricted, and preventive maintenance is instructed. For example, when an abnormal rise in a temperature sensor value is detected, a cooling device of the corresponding rack is automatically controlled, and shutdown of a server or automatic movement of a workload to another rack is executed as necessary. For example, when suspicious communication is detected in a network device, the corresponding communication is blocked, and a communication log of a related server or terminal is preserved as evidence. For example, when a resource abnormality or a suspicious virtual machine operation is detected in a virtualization infrastructure, temporary suspension of the corresponding virtual machine or review of resource allocation is automatically executed. For example, when a suspicious USB device connection or massive data transfer to an external storage is detected in an operation terminal, network isolation or device usage restriction of the corresponding terminal is immediately executed. For example, when a suspicious setting change or erasure of video data is detected in a surveillance camera, video of the corresponding camera is immediately backed up, and a warning is issued to the administrator. For example, when a suspicious entry/exit pattern or a series of authentication failures is detected in an entry/exit management system, an alarm is issued, and access restriction of the corresponding area is automatically executed. Specifically, the incident response unit receives a classification label and a certainty score of the abnormality output from the analysis unit. The incident response unit includes a security orchestration, automation, and response engine. The engine dynamically selects a machine-readable playbook based on the received label. The engine issues a control command to a management API of each infrastructure in accordance with a workflow defined in the playbook. The engine makes an API call to a hypervisor of the virtualization infrastructure to disable a virtual network interface of the virtual machine suspected of malware infection. The engine simultaneously issues a command to acquire a snapshot including a memory state of the virtual machine. The engine transmits a control signal to a programmable logic controller of an air conditioning facility to maximize a fan rotation speed of a rack where a localized heat pool has occurred. When the temperature does not fall below a threshold, the engine cooperates with a container orchestration tool to live-migrate a container pod on the corresponding rack to a physically distant normal node. The engine transmits a signal to forcibly lock a specific electronic lock to a controller of the entry/exit management system. The system executes these complex controls across cyberspace and physical space in milliseconds without human intervention. The system autonomously prevents both logical damage expansion due to a cyberattack and physical service stoppage due to a hardware failure. The system dramatically shortens a mean time to recovery in data center operations and strongly supports achievement of a service level agreement. The system provides extremely high operational continuity in an environment where physical rush response is difficult, such as an unmanned edge data center or a remote communication base station. The system can also adopt a variation configuration in which an execution order and parameters of the playbook are dynamically optimized based on past success cases using reinforcement learning. The system autonomously derives the most effective response procedure even for an unknown complex incident by this variation configuration.

The evidence management unit automatically classifies and organizes evidence data collected when an incident occurs, collectively preserves the evidence data in chronological order for each related incident, automatically extracts a communication packet, a file operation history, trace information of a system call, video data, an entry/exit log, and the like that become traces of an attack, and efficiently manages them in preparation for a forensic investigation or an audit at a later date. It also realizes prevention of falsification, encrypted preservation, and access authority management of the evidence data. Specifically, the evidence management unit receives a wide variety of binary data and text data transferred from the incident response unit. The evidence management unit executes a data normalization process on the received data. The evidence management unit converts the normalized data into a multidimensional tensor format. The evidence management unit inputs this tensor data into a clustering algorithm to automatically group an event group caused by the same incident. The evidence management unit executes data encryption on the grouped data set using an advanced encryption standard algorithm. The evidence management unit calculates a hash value of the encrypted data block. The evidence management unit records the calculated hash value in a private blockchain network based on a distributed ledger technology. The evidence management unit thereby mathematically guarantees integrity and non-falsification of the evidence data. The evidence management unit executes data lifecycle management for automatically hierarchically moving the encrypted data set from a high-speed solid state drive to an inexpensive tape storage based on requirements of access frequency and preservation period. The evidence management unit adopts an attribute-based access control model, and dynamically grants and revokes access authority to the data according to roles of a forensic investigator and an auditor. The system provides a strict digital forensic infrastructure at a level having evidence admissibility in court by this robust data management architecture. The system enables quick search and extraction of necessary data while optimizing a storage cost required for long-term preservation of massive evidence data. The system dramatically reduces a load of audit response in a global company that needs to comply with strict compliance regulations such as the Financial Instruments and Exchange Act and the General Data Protection Regulation. The system can also adopt a variation configuration in which personal information and confidential information are automatically detected from the evidence data using a natural language processing model, and shared with an external investigation agency after applying a masking process. The system realizes a secure third-party audit that completely eliminates an information leakage risk by this variation configuration.

The notification generation unit automatically generates a notification text or an incident report to the administrator based on information from the analysis unit or the incident response unit. The generative AI summarizes the content and impact range of the detected threat, and generates a text that conveys it to the administrator in an easy-to-understand manner. For example, it automatically generates a specific notification text such as “Massive external communication occurred in server A at an unusual time, and a suspicion of malware infection was detected. The corresponding server has been isolated from the network, and evidence data has been preserved.” In addition, when a plurality of incidents occur simultaneously, it automatically evaluates the impact range and priority, and generates a report including prioritization of responses. Specifically, the notification generation unit internally implements a large language model based on a transformer architecture. The notification generation unit receives a multidimensional threat vector output from the analysis unit. The notification generation unit receives a response completion flag output from the incident response unit. The notification generation unit collects time-series system log data. The notification generation unit converts these input data into a token sequence suitable for natural language processing. The large language model analyzes the input token sequence using a self-attention mechanism. The large language model infers a causal relationship between respective events. The large language model generates text data in natural language based on an inference result. The large language model simultaneously calculates a score indicating the priority of each incident as a continuous value in a range of 0.0 to 1.0. For example, the large language model receives input data of a threat score of 0.95 and an isolation completion flag of 1. The large language model outputs a label of a high urgency level and text data indicating a recommended response procedure. The notification generation unit converts the output text data into a structured markup language format. The notification generation unit transmits the converted data to a display module of an administrator terminal. The display module dynamically controls a display color of an alert and a volume of a warning sound based on the priority score. The system adopts such a non-conventional processing method. The system executes flexible text generation according to a situation, rather than simply filling in blanks of a boilerplate text. The system significantly reduces a cognitive load on the administrator. The system dramatically improves an initial response speed when an incident occurs. The system is applied to security operation tasks in a large-scale cloud data center or a core system of a financial institution.

The system optimization unit learns past detection results and feedback from the administrator, and automatically optimizes a detection model and a defensive rule. For example, for a server where false detections frequently occur, it learns an operation pattern specific to the server, and automatically adjusts a threshold to be regarded as normal thereafter. In addition, when a new attack method or failure pattern is discovered, it immediately updates the detection model based on information obtained from external threat intelligence, and reflects it in all devices. Specifically, the system optimization unit includes a parameter update module that executes an online learning algorithm. The parameter update module accumulates multidimensional feature vectors used in past inference processes. The parameter update module receives a feedback signal input from the administrator terminal. The feedback signal is expressed as label data of a value 1 indicating a true positive or a value 0 indicating a false positive. The parameter update module constructs a pair of the feature vector and the label data as a learning data set. The parameter update module recalculates a weight parameter matrix of a neural network using a gradient descent method. The parameter update module updates a connection weight of each node so as to minimize a cross-entropy error function. The parameter update module calculates a bias value for canceling a noise component depending on a specific server environment. The parameter update module dynamically adjusts a threshold vector for abnormality determination using the calculated bias value. The parameter update module extracts a feature amount of a new attack signature acquired from the external threat intelligence. The parameter update module maps the extracted feature amount to an existing model space. The parameter update module fine-tunes an output layer of the model using a transfer learning method. The system optimization unit distributes the updated weight parameter matrix to an inference engine of each edge node via a network. The inference engine expands the received parameters in a calculation area on a memory. The inference engine dynamically switches detection logic without stopping the system. The system realizes autonomous model improvement that does not depend on human manual tuning. The system continuously reduces a false positive rate. The system improves adaptability to unknown attack methods. The system achieves both reduction of operation costs and maintenance of a security level.

As described above, the system of the present invention collects and integrates various data generated from all devices and systems in a data center in real time, performs multidimensional and time-series analysis with a generative AI as a core, and integrally and autonomously executes abnormality detection, failure sign detection, cyberattack sign detection, automatic defense/automatic recovery, evidence management, notification generation, and system optimization, thereby making it possible to dramatically improve safety, availability, operational efficiency, and audit response capability of the data center against various risks such as cyberattacks, internal frauds, device failures, operational errors, environmental abnormalities, and physical intrusions. Specifically, the system functions as an integrated control module constructed on a distributed computing environment. The integrated control module projects data of heterogeneous formats into a single high-dimensional vector space. The integrated control module discovers hidden correlations among data through vector operations in the multidimensional space. The integrated control module simultaneously processes massive variables exceeding human cognitive limits. The integrated control module expresses a complex attack scenario that cannot be described by a rule-based system as a mathematical model. The integrated control module links data flows among respective submodules by an asynchronous messaging protocol. The integrated control module shortens latency from detection to response to a millisecond unit. The system is not merely a business efficiency improvement tool but a technical invention that improves processing efficiency of a computer architecture itself. The system realizes optimal allocation of hardware resources. The system suppresses wasteful consumption of a network bandwidth. The system guarantees extremely high availability in a large-scale cloud infrastructure or a control system of a critical infrastructure. The system functions as a dynamic access control infrastructure in a zero-trust network environment.

### System Configuration

The system according to the present embodiment includes a data collection unit, an analysis unit, an incident response unit, an evidence management unit, a notification generation unit, a system optimization unit, and an external threat intelligence cooperation unit. The data collection unit collects, in real time, operational data and security-related data generated from all IT devices and physical facilities in a data center, such as servers, storage devices, network devices, virtualization infrastructures, cloud cooperation environments, operation terminals, power supply facilities, air conditioning facilities, surveillance cameras, and entry/exit management systems. For example, from a server, it collects a CPU usage rate, a memory usage amount, a disk I/O, a process start/end log, an administrator privilege operation history, a system event log, a user authentication history, a file access history, an OS patch application history, a remote access history, a service start/stop history, an execution history of a backup job, an application log, a crash dump, traffic statistics of a network interface, and the like. From a storage device, it collects an access log, an error occurrence history, a capacity usage status, a RAID rebuild history, disk failure sign data, SMART information, a snapshot acquisition history, a state of inter-storage replication, a firmware update history of a storage controller, and the like. From a network device, it collects a traffic log, a communication destination IP address, a port number, a communication protocol, a communication amount, a blocked/permitted communication history, an ARP table change, abnormality detection of a MAC address, alert information of an IDS or IPS, a routing table change history, a VPN connection history, a QoS setting change history, a firmware update history of the network device, and the like. From a virtualization infrastructure, it collects a virtual machine start/stop history, a resource allocation change history, a live migration history, a virtual switch setting change history, traffic information of a virtual network, a virtual machine snapshot acquisition history, a virtual disk expansion/reduction history, an administrator operation history of the virtualization infrastructure, and the like. From a cloud cooperation environment, it collects an API access log, an authentication/operation history of external cooperation, a usage history of a cloud storage, a start/stop/snapshot acquisition history of a virtual machine on a cloud, a privilege change history of a cloud service, an issuance/revocation history of a cloud API key, a security group setting change history on a cloud, and the like. From an operation terminal, it collects a login history, a file transfer history, a USB device connection history, a remote desktop connection history, an administrator privilege escalation history, a network setting change history of the terminal, a virus scan history of the terminal, a software installation history of the terminal, and the like. From a power supply facility, it collects power consumption data, an abnormal voltage detection history, a battery state of a UPS, a power supply switching history, a generator start history, a redundant configuration state of a power supply system, and the like. From an air conditioning facility, it collects temperature sensor data, an operating status of a cooling device, an air conditioning setting change history, an abnormal temperature alert history, humidity sensor data, an air conditioning filter replacement history, and the like. From a surveillance camera, it collects video data, a motion detection log, a camera setting change history, a preservation/deletion history of recorded data, and the like. From an entry/exit management system, it collects an entry/exit log, an IC card authentication history, a biometric authentication history, an alarm occurrence history, a door opening/closing history, and the like. These data are transmitted to a centralized management module on a server side in real time or periodically, and are integrally managed. Specifically, the data collection unit acquires data via a lightweight agent program deployed at each endpoint. The agent program hooks a system call at a kernel level of an operating system. The agent program temporarily stores the acquired raw data in a memory buffer. The agent program activates a parsing processing module. The parsing processing module analyzes an unstructured text log using a regular expression. The parsing processing module maps an extracted field value to a key-value format data structure. The parsing processing module converts a categorical variable into a numerical vector by a one-hot encoding method. The parsing processing module standardizes continuous value data so as to have zero mean and unit variance. The parsing processing module complements a missing value using a linear interpolation algorithm. The parsing processing module adds a high-precision timestamp to each data point. The parsing processing module reconstructs the normalized data as a multidimensional time-series tensor. The agent program transmits the constructed tensor data to the centralized management module via an encrypted communication channel. The centralized management module expands the received tensor data in an in-memory database. The system converts data of heterogeneous formats into a unified mathematical expression. The system dramatically improves calculation efficiency in subsequent AI analysis. The system minimizes information loss in a data preprocessing stage. The system functions as a data integration infrastructure in a large-scale IoT environment or an edge computing environment.

The analysis unit uses a generative AI as an essential component, and analyzes the collected massive amount of data multidimensionally and in chronological order. The analysis unit utilizes a combination of a deep learning model, a time-series analysis model, a self-supervised learning model, a large language model, a generative adversarial network, and the like, learns past normal operational patterns, normal operation tendencies for each device, traffic tendencies of the entire data center, operation histories for each user, external threat intelligence information, and the like from a massive amount of data, and detects, in real time and with high accuracy, behaviors different from normal, correlation abnormalities among a plurality of data sources, signs of known or unknown cyberattacks, signs of failures, operational errors, environmental abnormalities, and the like. For example, it detects complex abnormal signs such as massive external communication during the day deviating from a normal pattern in which backup jobs are concentrated at night, a rapid increase in an error occurrence frequency and a rise in a temperature sensor value in a storage device, an abnormal increase in live migration of a virtual machine, a rapid increase in access to a normally unused cloud API from an operation terminal, a concentration of blocked communication to a specific IP address in a network device, suspicious process starts occurring simultaneously in a plurality of servers, unnatural escalation or continuous operation of administrator privileges, a suspicious API call or massive data transfer to an external storage in a cloud environment, a server shutdown occurring simultaneously with a UPS battery abnormality, an abnormality in an entry/exit log occurring simultaneously with a setting change of a surveillance camera, and a correlation between an abnormal temperature alert of an air conditioning facility and occurrence of a high load on a server. Specifically, the analysis unit implements a hybrid neural network combining a long short-term memory network and a self-attention mechanism. The analysis unit receives a multidimensional time-series tensor output from the data collection unit as input data. For example, the analysis unit processes a tensor in which 256-dimensional feature vectors continue for 100 time steps as an input. The neural network non-linearly transforms the input tensor through an activation function of a hidden layer. The neural network calculates relevance to current input data while retaining past context information. The neural network outputs an abnormality probability score at each time step as a continuous value from 0.0 to 1.0. The neural network simultaneously outputs a contribution vector indicating a weight of a feature amount that contributed to abnormality determination. For example, the neural network outputs an abnormality probability score of 0.92 and a vector indicating that a contribution of a network traffic dimension is high. The analysis unit compares the output abnormality probability score with a predetermined dynamic threshold. The analysis unit generates an abnormality detection event when the score exceeds the threshold. The analysis unit transmits the abnormality detection event and the contribution vector to the incident response unit. The system detects a minute correlation abnormality that cannot be discovered by single log monitoring by a mathematical approach. The system realizes objective threat evaluation that does not depend on human heuristic judgment. The system contributes to early discovery of highly concealed threats such as zero-day attacks and internal crimes.

The incident response unit automatically executes a defensive measure or a recovery measure against the abnormality, the threat, or the sign of failure detected by the analysis unit. When a suspicion of malware infection is detected in a server, the incident response unit automatically separates the corresponding server from the network, notifies the administrator, and preserves evidence data. When a sign of failure is detected in a storage device, it restricts access to the corresponding device and instructs preventive maintenance. When an abnormal rise in a temperature sensor value is detected, it automatically controls a cooling device of the corresponding rack, and executes shutdown of a server or automatic movement of a workload to another rack as necessary. When suspicious communication is detected in a network device, it blocks the corresponding communication and preserves a communication log of a related server or terminal as evidence. When a resource abnormality or a suspicious virtual machine operation is detected in a virtualization infrastructure, it automatically executes temporary suspension of the corresponding virtual machine or review of resource allocation. When a suspicious USB device connection or massive data transfer to an external storage is detected in an operation terminal, it immediately executes network isolation or device usage restriction of the corresponding terminal. When a suspicious setting change or erasure of video data is detected in a surveillance camera, it immediately backs up video of the corresponding camera and issues a warning to the administrator. When a suspicious entry/exit pattern or a series of authentication failures is detected in an entry/exit management system, it issues an alarm and automatically executes access restriction of the corresponding area. Specifically, the incident response unit includes a control script execution module containing a reinforcement learning agent. The control script execution module receives an abnormality probability score and a contribution vector from the analysis unit. The control script execution module generates a state vector indicating a current system state. The reinforcement learning agent receives the state vector and the contribution vector as inputs. The reinforcement learning agent infers an optimal defensive action using a policy gradient method based on a Markov decision process. The reinforcement learning agent outputs an index value of an action that maximizes an expected reward from among a plurality of possible actions. For example, the reinforcement learning agent outputs a numerical value of action ID 4. The control script execution module maps action ID 4 to a specific network port blocking command. The control script execution module issues an API call to a management interface of a target network switch. The control script execution module dynamically rewrites an access control list. The control script execution module acquires a status code of an execution result and transmits it to the evidence management unit. The system shortens a time from occurrence of an incident to completion of a response to a millisecond order. The system physically and logically contains horizontal expansion of damage. The system minimizes system downtime and guarantees business continuity.

The evidence management unit automatically classifies and organizes the evidence data collected when an incident occurs, stores them collectively in chronological order for each related incident, automatically extracts communication packets, file operation histories, system call trace information, video data, entry/exit logs, and the like serving as traces of an attack, and efficiently manages them in preparation for a forensic investigation or an audit at a later date. It also realizes prevention of falsification, encrypted storage, and access authority management of the evidence data. Specifically, the evidence management unit includes a hash generation module and a distributed storage controller. The evidence management unit receives raw data and execution logs transmitted from the incident response unit. The evidence management unit extracts metadata feature amounts from the received data. The evidence management unit clusters the data for each incident ID based on the extracted feature amounts. The hash generation module applies a SHA3 algorithm to the clustered data blocks to calculate cryptographic hash values. The hash generation module combines the calculated hash values with a hash value of a previous data block to construct a hash chain structure. The distributed storage controller encrypts the data blocks having the hash chain structure with an AES256 algorithm. The distributed storage controller distributes and writes the encrypted data to a plurality of physical drives. The evidence management unit holds an access control matrix defining access authority to each data block on a memory. The evidence management unit verifies a digital certificate of a request source when an access request occurs. The system mathematically proves the integrity and non-falsification of the evidence data. The system legally secures evidence admissibility in a subsequent forensic investigation. The system significantly streamlines a system audit process of a financial institution or a government agency with strict compliance requirements.

A notification generation unit automatically generates a notification text to an administrator and an incident report based on information from the analysis unit and the incident response unit. The generative AI summarizes a content and an impact range of the detected threat, and generates a text that conveys it to the administrator in an easy-to-understand manner. For example, it automatically generates a specific notification text such as “Massive external communication occurred in server A at an unusual time, and a suspicion of malware infection was detected. The corresponding server has been isolated from the network, and evidence data has been preserved.” In addition, when a plurality of incidents occur simultaneously, it automatically evaluates the impact range and priority, and generates a report including prioritization of responses. Specifically, the notification generation unit implements a transformer model functioning as a natural language processing engine. The natural language processing engine receives metadata including an incident occurrence time, an affected node ID, and a threat category as an input. The natural language processing engine embeds the input metadata into a prompt template to generate a context vector. The natural language processing engine inputs the context vector to a decoder network to calculate an appearance probability distribution of words. The natural language processing engine selects an optimal word sequence using a beam search algorithm to generate a natural language text. The natural language processing engine outputs the generated text as report data structured in a markup language. For example, the natural language processing engine outputs an incident overview and a recommended countermeasure procedure formatted in an HTML format. The notification generation unit passes the output report data to a PDF rendering engine. The notification generation unit transmits the generated PDF file to an email address of the administrator via an SMTP protocol. The system automatically converts complex technical data into a format that humans can intuitively understand. The system facilitates information sharing among incident response teams. The system contributes to speeding up post-response and preventing human errors.

A system optimization unit learns past detection results and feedback from the administrator, and automatically optimizes a detection model and a defensive rule. For a server where false positives frequently occur, it learns an operational pattern specific to the server, and automatically adjusts a threshold value to be regarded as normal thereafter. When a new attack method or failure pattern is discovered, it immediately updates the detection model based on information obtained from external threat intelligence, and reflects it on all devices. Specifically, the system optimization unit includes a retraining module that controls a continuous integration pipeline. The retraining module extracts a time-series data segment determined as a false positive from a database. The retraining module configures the extracted data segment as a mini-batch and inputs it to a neural network. The neural network performs a forward propagation process and outputs a predicted value. The retraining module calculates an error between the predicted value and a correct label. The retraining module calculates a gradient vector of a loss function using a backpropagation method. The retraining module multiplies the calculated gradient vector by a learning rate to update a weight parameter of the model. The retraining module automatically executes an accuracy evaluation test using a validation dataset on the updated model. The retraining module generates a binary file of a new model after confirming that the accuracy has improved. The retraining module commits the generated binary file to a version control system. The retraining module deploys the new model to each node in a production environment via an orchestration tool. The system realizes an adaptive system that autonomously evolves following environmental changes. The system prevents model obsolescence and maintains long-term detection accuracy. The system eliminates a manual retraining process by a data scientist and reduces operational costs.

An external threat intelligence cooperation unit automatically collects and analyzes signatures of new malware, methods of targeted attacks, abuse cases of zero-day vulnerabilities, suspicious IP address lists, industry-specific attack tendencies, attack warning information on the dark web, security-related information on SNS, published vulnerability information, attack campaign information shared in a security community, and the like from an external threat intelligence source, and updates the threat information database at any time. Specifically, the external threat intelligence cooperation unit includes a distributed web crawler module and a named entity recognition model. The crawler module periodically accesses an external website or API endpoint to acquire unstructured text data. The crawler module removes noise from the acquired HTML or PDF file and extracts plain text. The named entity recognition model receives the extracted plain text as an input. The named entity recognition model performs BIO tagging on each word in the text. The named entity recognition model extracts entities such as an IP address, a file hash value, and an attack method name. The named entity recognition model infers a relationship between the extracted entities and outputs knowledge graph data. For example, the named entity recognition model outputs graph edge data indicating that a specific IP address is associated with a specific malware family. The external threat intelligence cooperation unit stores the output knowledge graph data in a graph database. The external threat intelligence cooperation unit converts the updated data into a format referable from an inference engine of the analysis unit. The system incorporates the latest threat information occurring around the world into its own system in real time. The system prevents an initial delay in defense against an unknown threat. The system completely automates information collection work by a security analyst.

Specific examples of prompt sentences to be read by the generative AI when implementing the present invention include: “Analyze the following server logs, storage logs, network traffic data, temperature sensor data, entry/exit logs, and surveillance camera video data, detect behaviors different from normal and signs of unknown failures, attacks, and physical intrusions, and if there is an abnormality, summarize its content and estimated cause.”; “Update the existing threat information database based on the latest threat intelligence information collected from the outside, and generate new attack signatures and failure sign rules.”; “Organize the evidence data of the detected incidents in chronological order, and automatically generate an incident report for the administrator.”; and “Analyze the correlation of abnormalities occurring simultaneously in a plurality of servers and facilities, and estimate a scenario of a failure or an attack.” Specifically, the system includes a dynamic prompt generation module. The prompt generation module structures and combines a system prompt, context data, and a task instruction. The prompt generation module dynamically embeds the latest log data and metrics values acquired from the database into a placeholder. The prompt generation module transmits the generated text string to an input interface of a large language model. The large language model tokenizes the input prompt string and processes it in a self-attention layer. The large language model interprets the intention of the instructed task and outputs an analysis result text. For example, the large language model outputs a text logically explaining that the cause of the abnormality is a specific process runaway. The prompt generation module verifies the format of the output text and requests regeneration if necessary. The system stabilizes the inference accuracy of the large language model by incorporating a prompt engineering method into the system. The system suppresses hallucinations peculiar to AI and guarantees highly reliable output. The system makes it possible to adapt a single general-purpose AI model to various security tasks.

### Implementation Steps

Step 1: Start of multidimensional data collection. The data collection unit collects, in real time or periodically, a CPU usage rate, a memory usage amount, a disk I/O, a process start/end log, an administrator privilege operation history, a system event log, a user authentication history, a file access history, an OS patch application history, a remote access history, a service start/stop history, a backup job execution history, an application log, a crash dump, network interface traffic statistics, a storage access log, an error occurrence history, a RAID rebuild history, SMART information, network traffic, an IDS/IPS alert, a virtual machine operation history, an API access log, a USB device connection history, a power supply state, temperature sensor data, humidity sensor data, video data, an entry/exit log, and the like from all IT devices and physical facilities in a data center, such as servers, storage devices, network devices, virtualization infrastructures, cloud cooperation environments, operation terminals, power supply facilities, air conditioning facilities, surveillance cameras, and entry/exit management systems, and integrates them into a centralized management module on the server side. Specifically, in this data collection step, an agent program resident in each device monitors a performance counter and a log file of an operating system. The agent program formats the acquired data as a log entry in a JSON format. The agent program serializes the JSON data into a binary format such as a protocol buffer. The agent program transmits the serialized data to a message queuing system using an asynchronous communication protocol. The message queuing system buffers the received data in a queue on a memory. The centralized management module asynchronously dequeues the data from the queue and writes it to an in-memory database. This processing procedure realizes high-throughput data transfer while minimizing consumption of a network bandwidth. This processing procedure prevents data loss even during a temporary disconnection of the network. This processing procedure eliminates a bottleneck of data reading in a subsequent analysis process.
Step 2: Multidimensional abnormality detection and correlation analysis by generative AI. The analysis unit uses the generative AI as an essential component to analyze the collected massive amount of data multidimensionally and chronologically. The generative AI combines a deep learning model, a time-series analysis model, a self-supervised learning model, a large language model, a generative adversarial network, and the like, learns past normal operational patterns, normal operation tendencies for each device, traffic tendencies of the entire data center, operation histories for each user, external threat intelligence information, and the like, and detects, in real time and with high accuracy, behaviors different from normal, correlation abnormalities among a plurality of data sources, signs of known or unknown cyberattacks, signs of failures, operational errors, environmental abnormalities, and the like. A specific example of a prompt sentence to be read by the generative AI includes “Analyze the following server logs, storage logs, network traffic data, temperature sensor data, entry/exit logs, and surveillance camera video data, detect behaviors different from normal and signs of unknown failures, attacks, and physical intrusions, and if there is an abnormality, summarize its content and estimated cause.” Specifically, in this analysis step, an inference engine loads the multidimensional time-series tensor integrated in Step 1 onto a memory. The inference engine inputs the tensor data to an autoencoder network. The autoencoder network compresses the input data into a low-dimensional latent space and restores it to the original dimension again. The inference engine calculates a reconstruction error between the input data and the restored data. The inference engine outputs the magnitude of the reconstruction error as an abnormality score. The inference engine outputs a label of an abnormal cluster when the abnormality score exceeds a statistical control limit line. For example, the inference engine outputs an abnormality score of 15.4 and a label of an unknown communication pattern. The inference engine publishes the output label and score to a subsequent module via an event bus. This processing procedure makes it possible to detect an unknown abnormality by self-supervised learning using only normal data. This processing procedure captures a zero-day attack that cannot be handled by rule-based signature matching. This processing procedure speeds up identification of a root cause of a failure in a complex system environment.
Step 3: Automatic collection and analysis of external threat intelligence. The external threat intelligence cooperation unit automatically collects and analyzes signatures of new malware, methods of targeted attacks, abuse cases of zero-day vulnerabilities, suspicious IP address lists, industry-specific attack tendencies, attack warning information on the dark web, security-related information on SNS, published vulnerability information, attack campaign information shared in a security community, and the like from an external threat intelligence source, and updates the threat information database at any time. A specific example of a prompt sentence to be read by the generative AI includes “Update the existing threat information database based on the latest threat intelligence information collected from the outside, and generate new attack signatures and failure sign rules.” Specifically, in this intelligence collection step, an analysis module inputs text data of a scraped web page to a natural language processing model. The natural language processing model analyzes a context in the text and vectorizes a keyword related to a threat. The natural language processing model calculates a cosine similarity between vectors and clusters highly relevant information. The natural language processing model outputs structured threat indicator data. For example, the natural language processing model outputs a JSON object including a malicious domain name and a CVE number. The analysis module automatically inserts the output threat indicator data into a blacklist database of a detection engine. The analysis module rebuilds an index of the database and optimizes performance of a search query. This processing procedure always maintains freshness of the threat information in the latest state. This processing procedure completely eliminates manual data input work by a security person in charge. This processing procedure seamlessly integrates external knowledge into an internal defensive mechanism.
Step 4: Execution of automatic defensive measure/recovery measure and evidence preservation. The incident response unit automatically executes a defensive measure or a recovery measure against the abnormality, the threat, or the sign of failure detected by the analysis unit. For example, when a suspicion of malware infection is detected in a server, it automatically separates the corresponding server from the network, when a sign of failure is detected in a storage device, it restricts access to the corresponding device, when an abnormal rise in a temperature sensor value is detected, it automatically controls a cooling device of a corresponding rack, and when suspicious communication is detected in a network device, it blocks the corresponding communication. The evidence management unit automatically classifies and organizes the evidence data collected when an incident occurs, stores them collectively in chronological order for each related incident, and efficiently manages them in preparation for a forensic investigation or an audit at a later date. Specifically, in this response step, a control command issuing module receives a trigger signal from the analysis unit. The control command issuing module transmits an HTTP request to a management API of a target hardware device. The control command issuing module transmits a payload that dynamically rewrites an access control list of a network switch. The control command issuing module issues a suspend instruction of a virtual machine to a hypervisor of a virtualization infrastructure. The evidence management unit collects a series of these operation logs and related packet capture data. The evidence management unit arranges the collected data as leaf nodes of a Merkle tree structure and calculates a root hash. The evidence management unit records the calculated root hash in a smart contract of a blockchain network. This processing procedure stops damage expansion at the time of incident occurrence at a mechanical speed. This processing procedure eliminates a manual judgment delay and an operation error. This processing procedure guarantees cryptographic integrity of the preserved evidence data and enhances its value as legal evidence.
Step 5: Administrator Notification and Automatic Incident Report Generation. A notification generation unit automatically generates a notification text to an administrator and an incident report based on information from the analysis unit and the incident response unit. The generative AI summarizes the content and impact range of the detected threat, and generates a text that conveys them to the administrator in an easy-to-understand manner. A specific example of a prompt sentence to be read by the generative AI is “Please organize the evidence data of the detected incident in chronological order and automatically generate an incident report for the administrator.” Specifically, in this notification step, a report generation engine receives summary information of an incident response log and the evidence data as an input. The report generation engine sorts the input data in chronological order to construct a sequence of events. The report generation engine inputs the sequence data to a large language model. The large language model infers a causal relationship between the events and outputs an incident summary text in natural language. The large language model simultaneously outputs a text indicating steps of a recommended permanent measure. For example, the large language model outputs a text including a procedure for reviewing firewall rules. The report generation engine binds the output text to a UI component of a dashboard screen and renders it. The report generation engine calls an API of a push notification service according to an importance level and sends an alert to a mobile terminal. This processing procedure converts a complex system log into a format that a human can intuitively understand. This processing procedure significantly reduces the time required for the administrator to grasp the situation. This processing procedure equalizes the quality of post-response and eliminates individual dependency.
Step 6: System Optimization and Automatic Tuning. A system optimization unit learns past detection results and feedback from the administrator, and automatically optimizes a detection model and a defensive rule. For a server where false positives frequently occur, an operation pattern specific to the server is learned, and a threshold value considered normal thereafter is automatically adjusted. When a new attack method or failure pattern is discovered, the detection model is immediately updated based on information obtained from external threat intelligence, and is reflected in all devices. A specific example of a prompt sentence to be read by the generative AI is “Please optimize the detection model and the defensive rule based on the past detection results and the administrator feedback.” Specifically, in this optimization step, a retraining module extracts a pair of log data accumulated for a certain period and a feedback label as a learning data set. The retraining module inputs the extracted data set to a random forest algorithm. The random forest algorithm constructs a plurality of decision trees and recalculates a branch condition of each node. The random forest algorithm updates a selection criterion of a feature amount so as to maximize an information gain. The random forest algorithm outputs an updated hyperparameter and a branch condition of a new decision tree. For example, the random forest algorithm outputs a new threshold value regarding an access frequency to a specific port number. The retraining module serializes the output parameter and registers it in a model registry. The retraining module performs a rolling update of the new model to an inference pod in a production environment using a container orchestration tool. This processing procedure continuously improves the detection accuracy of the system. This processing procedure prevents deterioration of the model due to aging of the environment. This processing procedure significantly reduces human resources required for operation and maintenance.

### Specific Use Case

For example, when the system of the present invention is applied in a data center, it is configured to collect, in real time, various data generated from a plurality of IT devices and physical facilities such as a server group, a storage device, a network device, a virtualization infrastructure, a cloud cooperation environment, an operation terminal, a power supply facility, an air conditioning facility, a surveillance camera, and an access control system. For example, from the server, a CPU usage rate, a memory usage amount, a disk I/O, a process start/end log, an administrator privilege operation history, a system event log, a user authentication history, a file access history, an OS patch application history, a remote access history, a service start/stop history, an execution history of a backup job, an application log, a crash dump, traffic statistics of a network interface, and the like are collected. For example, from the storage device, an access log, an error occurrence history, a capacity usage status, a RAID rebuild history, disk failure sign data, SMART information, a snapshot acquisition history, a state of inter-storage replication, a firmware update history of a storage controller, and the like are collected. For example, from the network device, a traffic log, a communication destination IP address, a port number, a communication protocol, a communication amount, a blocked/permitted communication history, an ARP table change, an abnormality detection of a MAC address, alert information of an IDS or an IPS, a routing table change history, a VPN connection history, a QoS setting change history, a firmware update history of the network device, and the like are collected. For example, from the virtualization infrastructure, a virtual machine start/stop history, a resource allocation change history, a live migration history, a virtual switch setting change history, traffic information of a virtual network, a virtual machine snapshot acquisition history, a virtual disk expansion/reduction history, an administrator operation history of the virtualization infrastructure, and the like are collected. For example, from the cloud cooperation environment, an API access log, an authentication/operation history of external cooperation, a usage history of a cloud storage, a start/stop/snapshot acquisition history of a virtual machine on a cloud, a privilege change history of a cloud service, an issuance/revocation history of a cloud API key, a security group setting change history on the cloud, and the like are collected. For example, from the operation terminal, a login history, a file transfer history, a USB device connection history, a remote desktop connection history, an administrator privilege escalation history, a network setting change history of the terminal, a virus scan history of the terminal, a software installation history of the terminal, and the like are collected. For example, from the power supply facility, power consumption data, an abnormal voltage detection history, a battery state of a UPS, a power supply switching history, a generator start history, a redundant configuration state of a power supply system, and the like are collected. For example, from the air conditioning facility, temperature sensor data, an operating status of a cooling device, an air conditioning setting change history, an abnormal temperature alert history, humidity sensor data, an air conditioning filter replacement history, and the like are collected. For example, from the surveillance camera, video data, a motion detection log, a camera setting change history, a saved/deleted history of recorded data, and the like are collected. For example, from the access control system, an access log, an IC card authentication history, a biometric authentication history, an alarm occurrence history, a door opening/closing history, and the like are collected. Specifically, the system in this application example connects an edge computing node arranged in each physical rack and a sensor group via a network. The sensor group converts an analog signal into digital data and transmits it to the edge node. The edge node applies a moving average filter to the received raw data to remove high-frequency noise. The edge node formats the filtered data as tagged metrics data in a time-series database. The edge node batch-transfers the formatted data to an aggregation server on the cloud. The aggregation server writes the received data to a distributed file system for persistence. This configuration ensures scalability to process petabyte-class data generated from tens of thousands of devices without delay. This configuration dramatically reduces a traffic load on a core network by primary processing on the edge side. This configuration provides a digital twin infrastructure that integrally monitors data in a physical space and a cyber space.

The analysis unit analyzes the massive amount of data collected in this way multidimensionally and in chronological order with the generative AI as an essential component. For example, it detects, in real time, complex abnormal signs such as massive external communication during the day deviating from a normal pattern in which backup jobs are concentrated at night, a rapid increase in an error occurrence frequency and a rise in a temperature sensor value in a storage device, an abnormal increase in live migration of a virtual machine, a rapid increase in access to a normally unused cloud API from an operation terminal, a concentration of blocked communication to a specific IP address in a network device, simultaneous and frequent suspicious process starts in a plurality of servers, an unnatural escalation or continuous operation of administrator privileges, a suspicious API call or massive data transfer to an external storage in a cloud environment, a server shutdown occurring simultaneously with a UPS battery abnormality, an abnormality in an access log occurring simultaneously with a setting change of a surveillance camera, and a correlation between an abnormal temperature alert of an air conditioning facility and an occurrence of a high load on a server. Specifically, the analysis unit inputs a data point in an integrated multidimensional feature space to an abnormality detection algorithm. The abnormality detection algorithm pre-learns a distribution model of normal data as a Gaussian mixture model. The abnormality detection algorithm calculates a Mahalanobis distance between the input data point and the normal distribution model. The abnormality detection algorithm outputs the calculated distance as an abnormality degree score. For example, the abnormality detection algorithm outputs a high abnormality degree score with a distance value of 28.5. The analysis unit monitors a time-series change of the abnormality degree score by a sliding window method. The analysis unit calculates a primary differential value of the score and detects a rapid upward trend. The analysis unit calculates a contribution degree of each dimension of the data point exceeding a threshold value and identifies a root cause of the abnormality. This system detects a complex attack across systems that is overlooked by siloed individual monitoring tools. This system mathematically proves a correlation between a physical environmental change and a logical cyberattack. This system makes it possible to quantitatively evaluate the health of the entire data center with a single index.

Furthermore, an external threat intelligence cooperation unit automatically collects and analyzes a signature of a new malware, a method of a targeted attack, an abuse case of a zero-day vulnerability, a suspicious IP address list, an industry-specific attack tendency, attack warning information on the dark web, security-related information on SNS, published vulnerability information, attack campaign information shared in a security community, and the like from an external threat intelligence source, and updates the threat information database at any time. Specifically, the cooperation unit drives a data collection engine to acquire a security report in JSON format from an external RESTful API. The data collection engine inputs the acquired natural language text to a transformer-based classification model. The classification model evaluates a severity of a threat included in the text and outputs a category label. The classification model converts an IP address and a hash value extracted from the text into a machine-readable standard format and outputs them. For example, the classification model outputs threat object data described in STIX format. The cooperation unit merges the output threat object data into the internal threat information database. The cooperation unit push-distributes difference information of the updated database to a policy management server of each security device. The policy management server automatically generates and applies a drop rule of a firewall based on the received difference information. This system causes the entire system to immediately acquire immunity against an unknown threat discovered externally. This system functions as a virtual patch against a zero-day attack for which application of a security patch is not in time. This system continuously and automatically strengthens a boundary defense capability of an organization.

When an abnormality, a threat, or a sign of failure is detected by the analysis unit, the incident response unit automatically executes a defensive measure or a recovery measure. For example, when a suspicion of malware infection is detected in a server, the corresponding server is automatically separated from the network; when a sign of failure is detected in a storage device, access to the corresponding device is restricted; when an abnormal rise in a temperature sensor value is detected, a cooling device of the corresponding rack is automatically controlled; and when suspicious communication is detected in a network device, the corresponding communication is blocked. An evidence management unit automatically classifies and organizes the evidence data collected when an incident occurs, collectively stores the evidence data in chronological order for each related incident, and efficiently manages the evidence data in preparation for a forensic investigation or an audit at a later date. Specifically, the incident response unit receives an abnormality score and a threat classification label output from the analysis unit. The incident response unit refers to a predefined response policy rule base based on the received threat classification label. The incident response unit selects an optimal defensive action script from the response policy rule base. The incident response unit automatically issues the selected defensive action script to a target hardware device or virtual machine. When receiving a label indicating a suspicion of malware infection, the incident response unit transmits an API request to a software-defined network controller. By this API request, the incident response unit dynamically migrates a virtual network interface of the corresponding server to an isolated VLAN. By this isolation processing, the incident response unit physically and logically blocks lateral movement of the malware. When receiving a label indicating a sign of failure of a storage device, the incident response unit issues an IOPS restriction command to a storage controller. By this IOPS restriction, the incident response unit temporarily blocks write access to the corresponding storage volume. When receiving a label indicating an abnormal rise of a temperature sensor, the incident response unit transmits a rotation speed increase command for a cooling fan to an environmental control system of the data center. By this automatic control, the incident response unit prevents physical damage to hardware due to thermal runaway. When receiving a label indicating suspicious communication, the incident response unit transmits an update command for a dynamic access control list to an edge firewall. By this update, the incident response unit drops a packet from the corresponding source IP address at a hardware level. The evidence management unit acquires raw log data and packet capture data collected from each device simultaneously with the occurrence of the incident. The evidence management unit stores the acquired data in a time-series database. When storing the data in the time-series database, the evidence management unit assigns an incident identifier to each data record. By this incident identifier, the evidence management unit links log data collected from a plurality of different devices as a single incident context. The evidence management unit applies a graph neural network using self-supervised learning to this linking processing. The graph neural network receives a feature amount vector of each log entry as an input. The input feature amount vector of the graph neural network includes, for example, a numerical vector of a timestamp, an embedding vector of an IP address, and a distributed representation vector by natural language processing of a log message. The number of dimensions of an input tensor of the graph neural network is, for example, a three-dimensional tensor of a batch size, the number of nodes, and the number of feature amount dimensions. Specific examples of the input of the graph neural network include a vector of a firewall blocking log recorded at 2:15 AM, a vector of a server process start log recorded at 2:16 AM, and a vector of a database authentication failure log recorded at 2:17 AM. The graph neural network calculates temporal and spatial proximity among these input vectors. The graph neural network generates a probability score matrix indicating a degree of relevance among the respective log entries as an output. Specific examples of the output of the graph neural network include a score of 0.95 indicating a degree of relevance between the firewall log and the server log, a score of 0.88 indicating a degree of relevance between the server log and the database log, and a score of 0.02 indicating a degree of relevance with an irrelevant backup log. The evidence management unit compares each element of this probability score matrix with a predetermined threshold value. By this comparison, the evidence management unit groups a log entry group exceeding the threshold value as the same incident cluster. The evidence management unit encrypts this grouped data and stores it in a non-volatile storage. By this encrypted storage, the evidence management unit prevents data falsification and ensures the integrity of evidence preservation in a forensic investigation. By these automated responses and evidence management, this system eliminates a delay of manual intervention by a human operator. By this delay elimination, this system prevents expansion of damage caused by a cyberattack or a physical failure in units of milliseconds. By this processing, this system dramatically improves operational continuity of the data center. Specific application fields of this system include infrastructure management of a large-scale cloud service provider, protection of a mission-critical transaction system of a financial institution, and the like.

The notification generation unit automatically generates a notification text to the administrator and an incident report based on information from the analysis unit and the incident response unit. For example, it automatically generates a specific notification text such as “Massive external communication occurred in server A at an unusual time, and a suspicion of malware infection was detected. The corresponding server has been isolated from the network, and evidence data has been preserved.” Specifically, the notification generation unit receives structured data output from the analysis unit and the incident response unit. The notification generation unit utilizes a large language model based on a transformer architecture to convert this structured data into a natural language text. The notification generation unit deploys this large language model on a parallel computing cluster using a GPU inside the system. The large language model receives a string vector in JSON format including metadata of the incident as an input. The type of input data of the large language model is a tokenized text sequence. The number of dimensions of an input tensor of the large language model is, for example, a three-dimensional tensor of a batch size, a sequence length, and the number of embedding dimensions. Specific examples of the input of the large language model include numerical data indicating an incident occurrence time, string data indicating an affected host name, and categorical data indicating an executed defensive action. The large language model applies a self-attention mechanism to these input tokens. By this self-attention mechanism, the large language model calculates a contextual dependency among the respective data elements. The large language model generates a probability distribution of word tokens of natural language understandable by a human as an output. The output data format of the large language model is a sequence of probability vectors with respect to a vocabulary size. Specific examples of the output of the large language model include a generation probability of 0.99 for a token “in server A”, a generation probability of 0.95 for a token “of malware infection”, and a generation probability of 0.98 for a token “has been isolated”. The notification generation unit decodes a token sequence with the highest likelihood from this probability distribution. The notification generation unit applies a beam search algorithm to this decoding processing. The notification generation unit formats this decoded text as a final notification text. The notification generation unit transfers this notification text to an e-mail transmission module or an API endpoint of a chat application. By this automatic generation process, the notification generation unit enables the administrator to immediately grasp the situation of the incident. By this processing, the notification generation unit accurately conveys a context of a complex incident that could not be expressed by a conventional fixed template-based notification system. By this context conveyance, the notification generation unit significantly improves a decision-making speed of the administrator. The notification generation unit executes an extractive summarization algorithm to generate a more detailed incident report. By this extractive summarization algorithm, the notification generation unit extracts only important events from a massive amount of log data acquired from the evidence management unit. The notification generation unit sorts the extracted events in chronological order to construct a body of the report. By this report generation, the notification generation unit dramatically reduces human working time required for audit response and post-analysis. Specific application fields of this system include efficiency improvement of incident response work in a security operations center, automation of report creation for customers in a managed security service provider, and the like.

The system optimization unit learns past detection results and feedback from the administrator, and automatically optimizes the detection model and the defensive rule. For example, for a server where false positives frequently occur, an operation pattern specific to the server is learned, and a threshold value considered normal thereafter is automatically adjusted. When a new attack method or failure pattern is discovered, the detection model is immediately updated based on information obtained from external threat intelligence, and is reflected in all devices. Specifically, the system optimization unit controls a continuous learning pipeline of a machine learning model. The system optimization unit collects log data of detection results output in the past by the analysis unit and a feedback label of correctness determination by the administrator. The system optimization unit fine-tunes a weight parameter of a deep neural network using this collected data as training data. The system optimization unit uses an optimization algorithm based on a stochastic gradient descent method for this fine-tuning. The system optimization unit applies a reinforcement learning agent to a specific server environment where false positives frequently occur. The reinforcement learning agent receives a time-series tensor of a system resource usage rate of the corresponding server and a statistical feature amount vector of network traffic as an input. The number of dimensions of an input tensor of the reinforcement learning agent is, for example, a two-dimensional tensor of the number of time steps and the number of feature amount dimensions. Specific examples of the input of the reinforcement learning agent include a numerical array indicating a fluctuation of a CPU usage rate for the past 24 hours, a numerical array indicating a transition of a memory consumption amount, and a numerical array indicating an access frequency to a specific port. The reinforcement learning agent observes these input states and outputs a threshold parameter for abnormality detection as an action. The output data format of the reinforcement learning agent is an action vector of continuous values. Specific examples of the output of the reinforcement learning agent include an adjustment value for raising an abnormality determination threshold of the CPU usage rate from 80 percent to 90 percent, an adjustment value for changing an allowable upper limit of the number of network connections from 1000 to 1500, and a coefficient value for lowering detection sensitivity in a specific batch processing execution time zone. The system optimization unit applies this output threshold parameter to an abnormality detection module of the analysis unit. The system optimization unit evaluates detection accuracy after this application as a reward function. In this reward function, the system optimization unit gives a positive reward to an improvement in a true positive rate and gives a negative penalty to an increase in a false positive rate. The system optimization unit updates a policy network of the reinforcement learning agent so as to maximize this reward. By this dynamic threshold adjustment, the system optimization unit autonomously adapts to aging of the environment and fluctuations in a business cycle that cannot be handled by a static rule-based system. The system optimization unit receives a vector representation of a new attack signature from an external threat intelligence feed. The system optimization unit maps this vector representation to a latent space of an existing detection model. The system optimization unit uses a transfer learning method for this mapping processing. By this transfer learning, the system optimization unit immediately acquires a detection capability against an unknown threat without retraining the model from scratch. The system optimization unit asynchronously distributes this updated model parameter to all edge nodes on a distributed network. By this distribution processing, the system optimization unit uniformly and rapidly improves the defense capability of the entire system. By this series of processing, the system optimization unit reduces alert fatigue of the administrator due to false positives and optimizes response resources for true threats. Specific application fields of this system include integrated monitoring of an enterprise network in which various system configurations coexist, an endpoint security environment in which new malware variants occur daily, and the like.

Specific examples of prompt sentences to be read by the generative AI include “Please analyze the following server log, storage log, network traffic data, temperature sensor data, access log, and surveillance camera video data, detect a behavior different from normal and a sign of an unknown failure, attack, or physical intrusion, and if there is an abnormality, summarize its content and an estimated cause.”, “Please update the existing threat information database based on the latest threat intelligence information collected from the outside, and generate a new attack signature and a failure sign rule.”, “Please organize the evidence data of the detected incident in chronological order and automatically generate an incident report for the administrator.”, and “Please analyze a correlation of abnormalities occurring simultaneously and frequently in a plurality of servers and facilities, and estimate a scenario of a failure or an attack.” Specifically, this system dynamically constructs these prompt sentences as an input query to the large language model. In this prompt construction processing, this system converts raw multimodal data collected from each data source into a text representation or an embedding vector and embeds it in the prompt. For example, this system converts surveillance camera video data into an image feature amount vector using a convolutional neural network. This system projects this image feature amount vector into a token embedding space that can be processed by the large language model. The large language model receives a high-dimensional tensor in which an instruction sentence in natural language and an embedding vector of multimodal data are combined as an input. The type of input data of the large language model is a mixed sequence of a text token and an image patch feature amount. The number of dimensions of an input tensor of the large language model is, for example, a three-dimensional tensor of a batch size, a total sequence length, and the number of dimensions of a hidden layer. Specific examples of the input of the large language model include a token vector of an instruction sentence “Please analyze the following data”, a numerical vector of time-series data indicating a CPU spike of a server, and an image feature amount vector of a suspicious person captured by a surveillance camera. The large language model applies a multi-head attention mechanism to these input tensors. By this attention mechanism, the large language model calculates a cross-modal correlation between the instruction content of the text and an abnormal value of each sensor data. The large language model generates a probability distribution of text tokens describing the content of the abnormality and the estimated cause as an output. The output data format of the large language model is a generated text string and a certainty score for each abnormal event. Specific examples of the output of the large language model include a text output “A physical intrusion into the server room was detected at 3:00 AM”, a score of 0.98 indicating a certainty of the event, and an inference text “A rapid increase in network traffic that occurred simultaneously is highly likely to be an attempt to take out data”. This system transfers this output text and certainty score to the subsequent incident response unit. This system triggers an automatic defensive script only when the certainty score exceeds a predetermined threshold value. When processing a prompt regarding an update of threat intelligence information, this system uses a threat data vector in STIX format acquired from the outside as an input. From this input, the large language model automatically generates and outputs a regular expression rule and a YARA rule of a new attack pattern. After verifying this output rule with a parser, this system dynamically applies it to a detection engine of each security device. When processing a prompt regarding a correlation analysis of simultaneous and frequent abnormalities in a plurality of facilities, this system uses graph structure data of an alert log of each facility as an input. From this graph structure data, the large language model estimates a path of lateral movement of an attacker and outputs a timeline of an attack scenario. By integrating this advanced prompt engineering and multimodal analysis, this system reproduces an advanced inference process performed by a human security analyst on a computer at high speed and accurately. By this processing, this system dramatically improves a detection capability and a response speed against an unknown complex cyber-physical attack. Specific application fields of this system include an integrated security monitoring center of a critical infrastructure facility, proactive threat hunting work against an advanced targeted attack, and the like.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

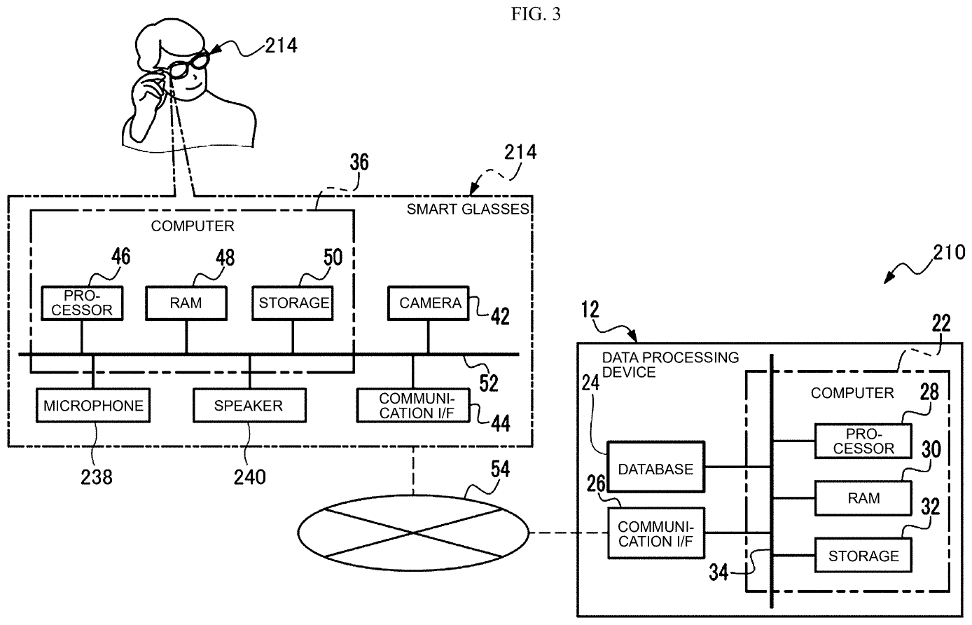

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

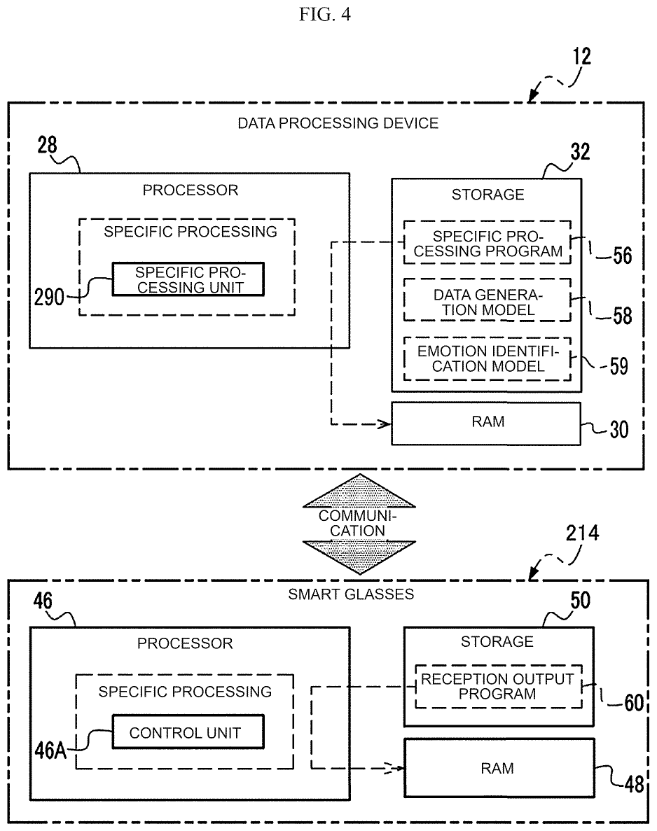

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### (Example 1)

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

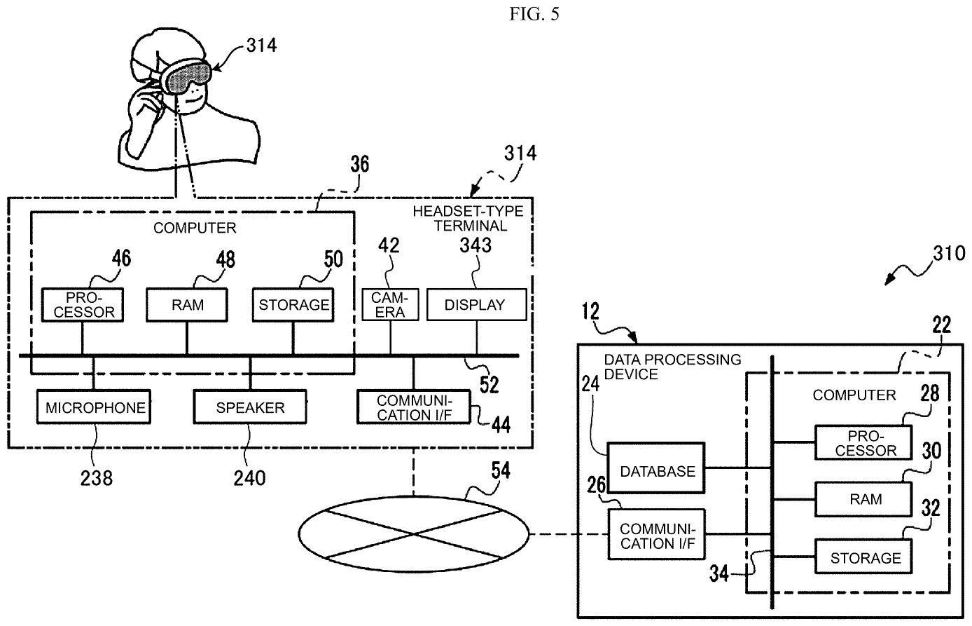

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

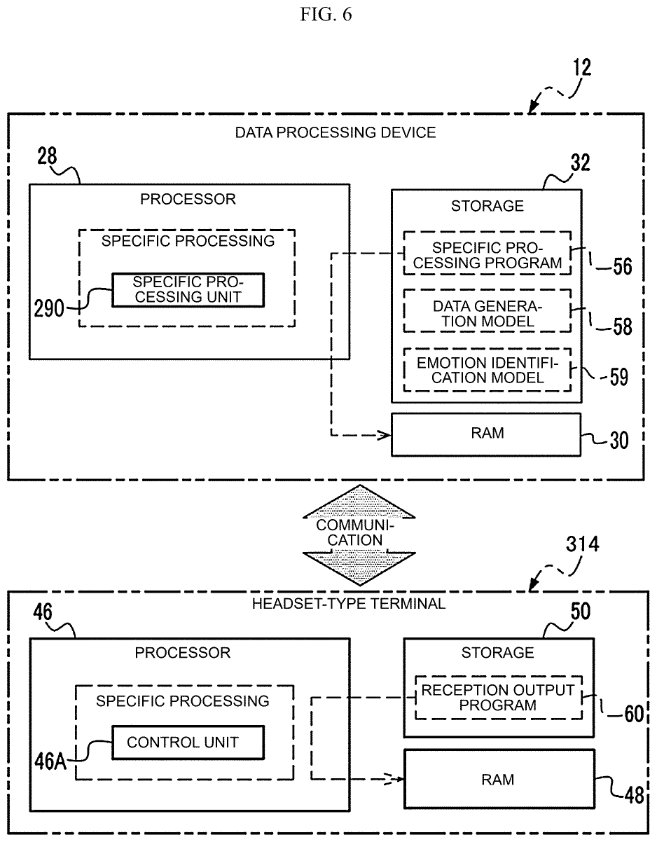

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

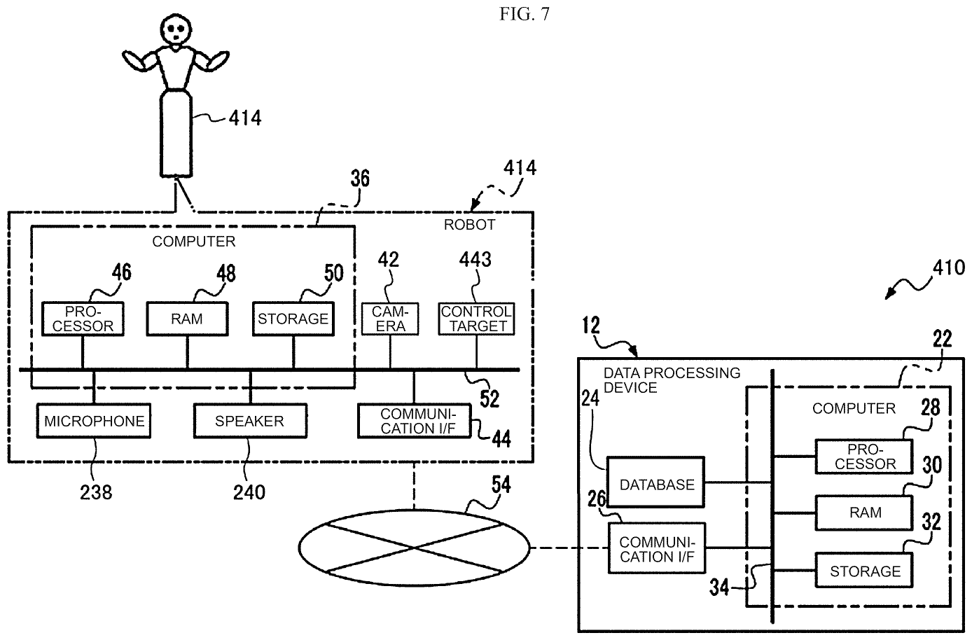

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

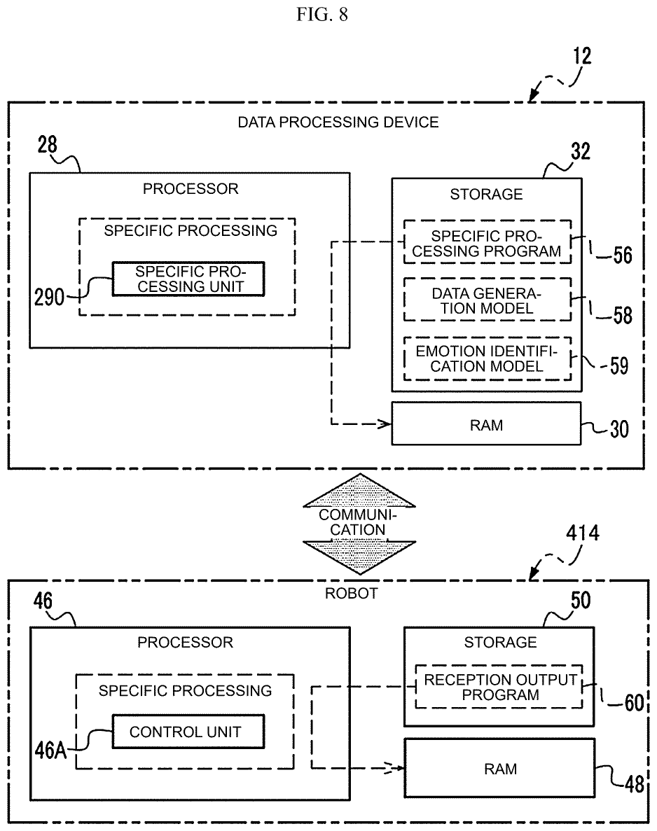

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

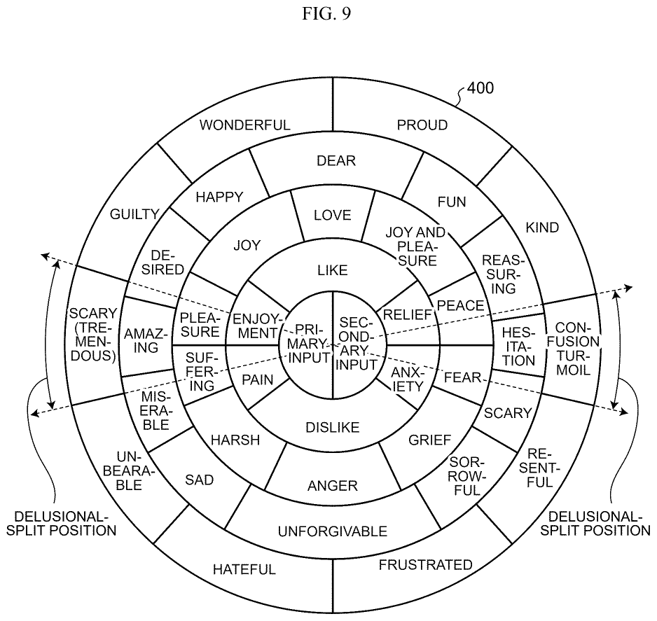

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

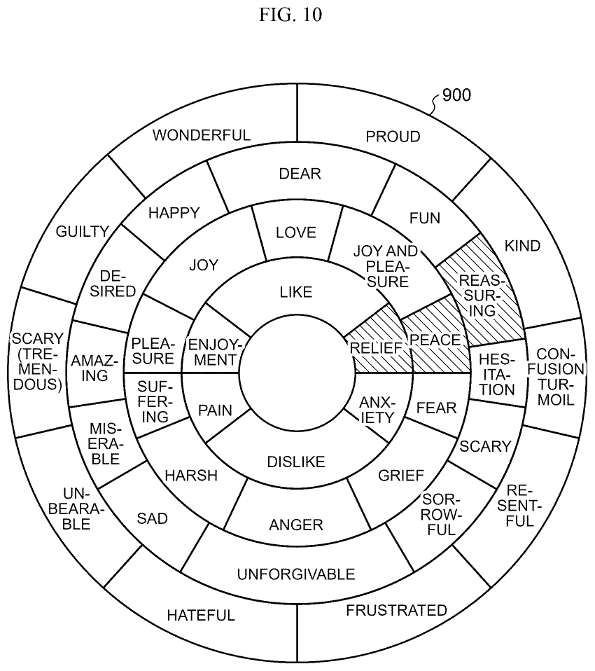

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### (Supplementary Note 1)

A system comprising: a data collection unit configured to collect, in real time, operational data and security-related data generated from a plurality of types of devices and systems such as servers, storage devices, network devices, virtualization infrastructures, cloud cooperation environments, operation terminals, power supply facilities, and air conditioning facilities in a data center; an analysis unit configured to analyze the massive amount of data collected by the data collection unit with a generative AI as an essential component, learn past normal operational patterns, normal operation tendencies for each device, traffic tendencies of the entire data center, operation histories for each user, external threat intelligence information, and the like, and detect, in real time and with high accuracy, behaviors different from normal, correlation abnormalities among a plurality of data sources, signs of known or unknown cyberattacks, signs of failures, operational errors, environmental abnormalities, and the like; and an incident response unit configured to automatically execute a defensive measure or a recovery measure against the abnormality, the threat, or the sign of failure detected by the analysis unit, and perform network separation of a corresponding device, communication blocking, automatic control of a cooling device, a preventive maintenance instruction, a resource allocation change of a virtual machine, preservation of evidence data, notification to an administrator, automatic generation of an incident report, and the like, wherein the analysis unit is configured to automatically collect and analyze external threat intelligence information using the generative AI to dynamically update a threat information database, the incident response unit is configured to record all response histories in chronological order and manage the evidence data so that the administrator can utilize the evidence data when conducting a forensic investigation or an audit at a later date, and further, a system optimization unit is configured to learn past detection results and feedback from the administrator to automatically optimize a detection model and a defensive rule.

### (Supplementary Note 2)

The system according to Supplementary Note 1, wherein the data collection unit is configured to comprehensively collect a CPU usage rate, a memory usage amount, a disk I/O, a process start/end log, and an administrator privilege operation history of a server, an access log, an error occurrence history, and a capacity usage status of a storage device, a traffic log, a communication destination IP address, a port number, a communication protocol, a communication amount, and a blocked/permitted communication history of a network device, a virtual machine start/stop history, a resource allocation change history, and a live migration history of a virtualization infrastructure, an API access log of a cloud cooperation environment, an authentication/operation history of external cooperation, a login history, a file transfer history, and a USB device connection history of an operation terminal, power consumption data and an abnormal voltage detection history of a power supply facility, temperature sensor data of an air conditioning facility, an operating status of a cooling device, and the like, centrally manage these various data on a server side, and integrate the data with data transmitted from a terminal side.

### (Supplementary Note 3)

The system according to Supplementary Note 1, wherein the analysis unit is configured to analyze time-series changes and correlations among a plurality of data sources of the collected data using the generative AI, and compositely detect a plurality of abnormal signs such as, for example, massive external communication during the day deviating from a normal pattern in which backup jobs are concentrated at night, a rapid increase in an error occurrence frequency and a rise in a temperature sensor value in a storage device, an abnormal increase in live migration of a virtual machine, a rapid increase in access to a normally unused cloud API from an operation terminal, and a concentration of blocked communication to a specific IP address in a network device, and the incident response unit is configured to immediately execute various automatic measures such as network separation of a corresponding device, cooling device control, temporary suspension of a virtual machine, preservation of evidence data, and notification to an administrator.

What is claimed is:

1. A system comprising:
circuitry configured to:
receive, via a communication interface coupled to a packet-switched network, network traffic data streams and system log data streams from a plurality of infrastructure components in real time, cache the received data in an in-memory database, and input the cached data to a large-scale multimodal neural network based on a transformer architecture;
apply the multimodal neural network to the network traffic data streams and system log data streams to project the data into a common latent feature space, compute anomaly detection scores by comparing projected feature vectors against normal behavior baseline distributions, and generate threat indicator records when anomaly detection scores exceed detection threshold parameters;
automatically acquire latest threat intelligence data from external threat intelligence service endpoints via the communication interface, update a threat information database with the acquired threat intelligence records, and apply the multimodal neural network to correlate current threat indicator records with threat intelligence patterns;
apply an automated incident response model to confirmed threat indicator records to generate defensive measure command sequences, and execute the defensive measure commands by transmitting control commands to infrastructure control endpoints via the communication interface; and
transmit alert data records, incident response records, and evidence preservation records to terminal devices via the communication interface.

2. The system according to claim 1, wherein the circuitry is configured to construct a digital twin environment of the infrastructure by integrating multidimensional time-series data from both physical infrastructure sensor devices and virtual infrastructure software agents, maintaining a synchronized virtual state model that reflects the current security posture of all monitored infrastructure components.

3. The system according to claim 2, wherein the circuitry is configured to apply the multimodal neural network to the digital twin environment state to project physical sensor data and virtual software agent telemetry into a unified latent representation, and compute anomaly detection scores by comparing the unified representation against normal operation baseline vectors stored in the in-memory database.

4. The system according to claim 1, wherein the circuitry is configured to acquire streaming data at high frequency from sensor nodes and software agents distributed across the infrastructure, applying an asynchronous acquisition protocol that caches data with sub-millisecond latency in the in-memory database, and enabling real-time query processing of the cached data.

5. The system according to claim 1, wherein the circuitry is configured to apply a graph neural network to a network topology graph comprising infrastructure component nodes and communication link edges, execute message passing operations to propagate anomaly indicator scores across connected nodes, and identify attack propagation paths by tracing high-anomaly-score edges between infrastructure component nodes.

6. The system according to claim 5, wherein the circuitry is configured to generate a threat propagation analysis record from the identified attack propagation paths, the threat propagation analysis record comprising affected infrastructure component identifiers, estimated threat entry point identifiers, and recommended containment scope parameters, and incorporate the threat propagation analysis record in the defensive measure command sequence.

7. The system according to claim 1, wherein the circuitry is configured to apply the automated incident response model to generate defensive measure command sequences by retrieving relevant historical incident response records from a vector database by cosine similarity search using a query embedding derived from the threat indicator record, and generating an optimal response command sequence by autoregressive decoding conditioned on the retrieved historical records.

8. The system according to claim 7, wherein the circuitry is configured to execute the defensive measure commands by transmitting access blocking commands to network control interfaces and isolation commands to virtualization management endpoints via the communication interface, receive execution confirmation records from the control interfaces, and store execution timestamps and status codes in an incident log data structure.

9. The system according to claim 1, wherein the circuitry is configured to preserve forensic evidence by capturing memory state snapshots from affected infrastructure components, applying a hash function to each captured snapshot to generate an integrity hash value, and storing the snapshots with their integrity hash values in a tamper-resistant evidence archive in the storage device.

10. The system according to claim 9, wherein the circuitry is configured to generate a forensic analysis report by applying the multimodal neural network to the captured memory state snapshots and incident log data to reconstruct a timeline of the threat activity, identify affected data records, and generate a natural language incident summary for transmission to terminal devices.

11. The system according to claim 1, wherein the circuitry is configured to apply an autonomous recovery model to restore affected infrastructure components to operational status following incident containment by identifying the last known good configuration state from version history records in the storage device, applying configuration restoration commands to affected components, and verifying restoration success by comparing restored component telemetry against normal baseline vectors.

12. The system according to claim 1, wherein the circuitry is configured to monitor the threat information database for new threat intelligence records that match current infrastructure component configuration signatures, generate a proactive vulnerability alert when a match is found, and transmit the proactive vulnerability alert with a recommended mitigation action sequence to terminal devices associated with security management user identifiers.

13. The system according to claim 1, wherein the circuitry is configured to apply a self-learning update procedure to the multimodal neural network by generating training examples from validated incident records and corresponding confirmed threat labels, and updating the network weights using a continual learning procedure that preserves normal behavior baseline accuracy while improving threat detection sensitivity.

14. The system according to claim 1, wherein the circuitry is configured to generate a unified security operations dashboard data record from anomaly detection scores, threat indicator records, incident response records, and threat information database coverage metrics, and transmit the dashboard data record to terminal devices associated with security operations user identifiers.

15. The system according to claim 1, wherein the circuitry is configured to apply an energy management model to infrastructure component power consumption telemetry and predicted workload demand data to generate power state adjustment recommendations, compute a projected energy efficiency improvement metric, and transmit the recommendations to terminal devices associated with infrastructure management user identifiers.

16. The system according to claim 1, wherein the circuitry is configured to transmit alert notifications to terminal devices via the communication interface within a maximum latency threshold from threat indicator detection, apply a priority routing algorithm to deliver critical severity alerts to terminal devices associated with incident response user identifiers before routine severity alerts.

17. The system according to claim 1, wherein the infrastructure components comprise network devices, server systems, storage systems, and virtualization platforms, the multimodal neural network processes heterogeneous telemetry from both physical and virtual infrastructure layers, and the defensive measure commands implement access blocking, isolation, and traffic filtering responses to detected threats.

18. A system comprising:
circuitry configured to:
receive, via a communication interface coupled to a packet-switched network, network traffic and system log data streams from infrastructure components, cache data in an in-memory database, and apply a multimodal neural network with transformer architecture to project data into a common latent feature space;
compute anomaly detection scores against normal baseline distributions, correlate threat indicators with external threat intelligence data, and apply a graph neural network to a network topology graph to identify attack propagation paths;
apply an automated incident response model to generate defensive command sequences, execute commands via infrastructure control endpoints, and preserve forensic evidence with integrity hashing;
apply an autonomous recovery model to restore affected components; and
transmit alert data, incident response records, and forensic analysis reports to terminal devices.

19. The system according to claim 18, wherein the circuitry is configured to apply a self-learning update procedure to the multimodal neural network using validated incident records, generate proactive vulnerability alerts when new threat intelligence matches current configuration signatures, and apply an energy management model to generate power state adjustment recommendations.

20. A method comprising:
receiving, via a communication interface coupled to a packet-switched network, network traffic data streams and system log data streams from infrastructure components in real time, and caching the data in an in-memory database;
applying a multimodal neural network to project data into a common latent feature space and compute anomaly detection scores, and generating threat indicator records when scores exceed threshold parameters;
updating a threat information database from external threat intelligence services, and applying an automated incident response model to generate defensive measure command sequences;
executing defensive measure commands via communication interfaces and preserving forensic evidence with integrity hash values; and
transmitting alert data records, incident response records, and evidence preservation records to terminal devices.
